(19) United States
(12) Patent Application Publication
(10) Pub. No.: US 2026/0094270 A1
(43) Pub. Date: Apr. 2, 2026

(54) METHODS AND SYSTEMS FOR DETERMINING AN ANATOMICAL RECONSTRUCTION OF A BROKEN BONE

(71) Applicants: Matthias VANHEES, Wilrijk (BE); Universiteit Antwerpen, Antwerpen (BE); IMEC VZW, Leuven (BE); MORE INSTITUTE VZW, Deurne (BE)

(72) Inventors: Jan SIJBERS, Wilrijk (BE); Femke DANCKAERS, Wilrijk (BE); Jana OSSTYN, Wilrijk (BE)

(73) Assignees: Matthias VANHEES, Wilrijk (BE); Universiteit Antwerpen, Antwerpen (BE); IMEC VZW, Leuven (BE); MORE INSTITUTE VZW, Deurne (BE)

(21) Appl. No.: 19/115,554

(22) PCT Filed: Sep. 29, 2023
(86) PCT No.: PCT/EP2023/077151

§ 371 Date: Mar. 26, 2025

(30) Foreign Application Priority Data
Sep. 30, 2022 (EP) 22199229.0

(51) Int. Cl. G06T 7/00; G06T 19/20

(52) U.S. Cl. CPC G06T 7/0014; G06T 19/20; G06T 2207/30008; G06T 2219/2008

(57) ABSTRACT

The present disclosure relates to the field of medical image processing and, more in particular, to a method for determining an anatomical fracture reconstruction based on one or more medical images of a broken bone, and a system configured for the same. According to an aspect the method comprises the steps of: receiving medical image data associated with the broken bone, identifying the plurality of bone fragments in the medical image data, generating a plurality of 3D surface models that virtually represent the bone fragments; registering a plurality of landmarks matching the surface models; generating a reconstructed model representing a reconstructed form of the broken bone by selecting at least two landmarks; generating a template model representing an optimal alignment of the surface models; repositioning the surface models to align at the selected landmarks set using the template model as reference; iteratively refining the reconstructed model by selecting different landmarks; changing the position of the surface models to align at the different landmarks; evaluating a quality measure that quantifies how changing the position affects the quality of the reconstructed model until a stopping condition is satisfied; and determining an anatomical reconstruction of the broken bone by comparing the position of the identified bone fragments in the medical image data with the position of the corresponding surface models in the reconstructed model.

### FIELD OF THE INVENTION

The present disclosure relates to the field of medical image processing and, more in particular, to a method for determining an anatomical fracture reconstruction based on one or more medical images of a broken bone, and a system configured for the same.

### BACKGROUND

The treatment of bone fractures is one of the more common procedures in hospital accident and emergency departments. In the most favourable scenario, a simple plaster treatment may suffice, but often, an invasive medical procedure such as surgery is required to reconstruct the broken bone from the displaced fragments. For example, in an “open reduction internal fixation” procedure for a distal radius fracture, the surgeon makes an incision in the wrist, restores the shape and functionality of the broken radius, and stabilises the fragments using plates and screws.

Before any medical procedure, however, the surgeon must first determine how to correctly align all the broken bone fragments. This necessitates detailed planning to assemble the fragments optimally. In this regard, medical images, such as those acquired by X-ray or computed tomography (CT) scanners, provide an indication of the number of bone fragments that need reassembly and localisation in their respective positions. Such indications enable surgeons to utilise virtual planning tools, allowing them to view and manipulate sections of a bone image to determine how the bone fragments should be repositioned for bone reconstruction.

Virtualising the surgical procedure for preoperative planning can enhance procedure accuracy, resulting in improved anatomical bone reconstruction and increased stability. Consequently, this can shorten recovery time and reduce the risk of complications. Therefore, algorithms for virtual bone reconstruction are highly desirable in the healthcare industry.

Many fragment repositioning tools described in the literature are interactive or semi-automatic. Interactive tools involve bone fragment alignment and fitting that necessitate input from the user. For instance, a method may involve matching two fracture faces, where the surgeon indicates several points of interest on one fragment and selects corresponding points on the complementary fragment. While effective, such interactive approaches require the full attention of the surgeon and are time-consuming. Furthermore, they rely on the surgeon's proficiency and experience with the tool, making their accuracy contingent on the type and complexity of the fracture.

On the other hand, semi-automatic tools require less frequent and less complex user intervention. For instance, a method may require manual identification of bone fragments, after which the identified fragments are separated and registered automatically. While semi-automated tools represent an improvement over the more interactive approaches, they are still susceptible to errors and can be time-consuming.

Accordingly, there is a need to address the limitations of state-of-the-art methods for determining the anatomical fracture reconstruction in broken bones, which can be advantageously enhanced through automation and autonomy, without requiring human input or intervention.

### SUMMARY OF THE INVENTION

As described above, there is a need to address the limitations of state-of-the-art methods for determining anatomical fracture reconstructions in broken bones. Therefore, this present disclosure introduces a technology that enhances the process of bone reconstruction. Specifically, the disclosed technology relates to a method for determining anatomical reconstructions based on one or more medical images of a fractured bone, along with a corresponding system configured for this purpose.

The method distinguishes itself from traditional approaches that rely on manual inputs and human expertise, at least to some extent, by achieving anatomical reconstruction in an automated manner, without requiring human input or intervention. The automatic reconstruction method can be considered to consist of two phases. In the first phase, there is what can be considered ‘coarse’ alignment of the 3D surface models that virtually represent the broken bone fragments. During this phase, the method can leverage automatic landmark detection to initiate the alignment process. During the second stage, a reduction algorithm can be utilized to automatically refine the coarse alignment and achieve the best possible result.

The technical advantages associated with the automatic reconstruction method of claim are evident in the absence of the need for human interaction, such as manual landmark identification and selection, (pre-) alignment of bone fragments, or adjustments to the reconstruction. This not only frees up valuable time for the surgeon but also ensures a reliable and accurate reconstruction, irrespective of the surgeon's prior experience and expertise.

The method further distinguishes itself in the accuracy of automatic landmark detection, which aims identify the largest region on bone fragment having similar curvature and normal direction. These region can be presumed to be located on the exterior of the radius and typically correspond to a point on the target surface. Nonetheless, it is important to appreciate that while automatic, embodiment of the landmark selection process can be subjected to specific constraints that mitigate the likelihood of misalignments, which are known to be a challenge in standard shape matching algorithms.

The method further distinguishes itself in the computation of a metric or score that automatically quantifies how closely the aligned 3D models match an optimal configuration. Within the present context, this metric can serve as a measure of surface model alignment quality. The primary objective of the refinement is to achieve a ‘reduction’ in this quality measure through a dynamic process of iterative adjustments to the alignment parameters or variables. Moreover, the reduction process can be guided by comparing the reconstructed model to a reference model representing an optimal alignment. Consequently, a reduced quality measure signifies a closer match to the optimal alignment.

The technical advantages associated with the improved alignment quality extend the method to accommodate bone fragments of any number, size, and shape, regardless of the complexity of the fracture. This capability is particularly valuable when dealing with complex bone fractures, especially those involving joint-related injuries, such as the shoulder, elbow, knee, and others. Human input is known to be highly unreliable for fractures involving numerous small fragments with undefined shapes. In contrast, the disclosed method exhibits robustness, effectively addressing challenges such as imperfect segmentation in fractured areas and handling missing or poorly segmented parts.

A first overview of various aspects of the technology according to the present disclosure is given hereinbelow, after which specific embodiments will be described in more detail. This first overview is meant to aid the reader in understanding the technological concepts more quickly, but it is not meant to identify the most important or essential features thereof, nor is it meant to limit the scope of the present disclosure.

An aspect of the present relates to a computer-implemented method for automatically determining an anatomical reconstruction of a broken bone, whereby the broken bone is broken into a plurality of bone fragments; the method comprising the steps of: receiving medical image data associated with the broken bone, identifying the plurality of bone fragments in the medical image data, generating a plurality of 3D surface models that virtually represent the bone fragments; registering a plurality of landmarks matching the surface models; generating a reconstructed model representing a reconstructed form of the broken bone by selecting at least two landmarks; generating a template model representing an optimal alignment of the surface models; repositioning the surface models to align at the selected landmarks set using the template model as reference; iteratively refining the reconstructed model by selecting different landmarks; changing the position of the surface models to align at the different landmarks; evaluating a quality measure that quantifies how changing the position affects the quality of the reconstructed model until a stopping condition is satisfied; and determining an anatomical reconstruction of the broken bone by comparing the position of the identified bone fragments in the medical image data with the position of the corresponding surface models in the reconstructed model.

Another aspect of the present relates to a computer-implemented method for automatically determining an anatomical reconstruction of a broken bone, whereby the broken bone is broken into a plurality of bone fragments; the method comprising the steps of:
Receiving medical image data associated with the broken bone.
Identifying the plurality of bone fragments in the medical image data, generating a plurality of three-dimensional (3D) surface models that virtually represent the bone fragments, including at least a first and a second surface model, and registering a plurality of landmarks matching the first to the second surface model. The registration of landmarks involves identifying a plurality of vertex regions on the first and the second surface models, wherein a vertex region comprises a plurality of vertices with comparable curvature and normal direction, and matching one or more vertex regions of the first surface model with one or more vertex regions of the second surface model in accordance with a predefined matching criterion.
Generating a reconstructed model that represents a reconstructed form of the broken bone by selecting at least two landmarks yielding the highest degree of correspondence; providing a reference model that represents an unbroken form of the bone; and positioning the second surface model to align with the first surface model at the selected landmarks using the reference model as a reference. Optionally, repeating the positioning for each of the plurality of surface models until all surface models are aligned at corresponding landmarks relative to the reference model.
Iteratively refining the reconstructed model by selecting one or more different landmarks, repositioning the second surface model to align with the first surface model at the different landmarks, and evaluating a quality measure that quantifies how the repositioning affects the quality of the reconstructed model, until a stopping condition is satisfied. The quality measure comprises comparing the reconstructed model to the reference model, thereby identifying one or more alignment discrepancies between the reconstructed model and the reference model, and assigning a score to the alignment discrepancies based on one or more reconstruction metrics.
Determining an anatomical reconstruction of the broken bone by comparing the position of the identified bone fragments in the medical image data with the position of the corresponding surface models in the reconstructed model.

Another aspect of the present disclosure relates to a computer-implemented method for determining an anatomical reconstruction of a broken bone, whereby said bone is broken into two or more fragments; the method comprising the steps of:
receiving image data associated with the broken bone;
identifying a plurality of fragments in said image data, generating a surface model for each identified fragment, defined by one or more geometric parameters, and assigning one or more landmarks to said surface models;
generating a reconstructed model of the broken bone by repositioning one or more of the surface models, based on the landmarks, to align with the plurality of surface models;
iteratively refining the reconstructed model by changing the position of one or more of the surface models, and evaluating a cost function that measures how a reconstruction metric is affected by said change in position, until a stopping condition is satisfied,
determining an anatomical reconstruction of the broken bone by associating the plurality of identified fragments with the corresponding surface model in the reconstructed model.

In some embodiments the landmark set comprises at least three non-collinear landmarks that do not lie along a straight line.

In some embodiments the surface model is generated by creating a geometric model that completely encloses one of the identified bone fragments, and iteratively shrinking the geometric model towards the surface of the bone fragment until it approximates the shape of the bone fragment; preferably wherein the geometric model comprises a sphere.

In some embodiments the vertex region is identified by selecting a first vertex on the surface model, comparing the normal direction of the first vertex region with the normal directions of adjacent vertices, including one or more adjacent vertices into the vertex region if the angle between the normal directions is within a predefined threshold; and repeating these steps for each vertex included in the vertex region until a stopping condition is satisfied;

In the above embodiment the predefined threshold includes calculating the dot product between the normal ray of the first vertex and the normal ray of each adjacent vertex, and expanding the vertex region to include the adjacent vertex is the dot product is between 0.0 and 0.8, preferably between 0.0 and 0.5. In some embodiments the predefined matching criterion comprises selecting at least a portion of vertices within a first vertex region of the first surface model and a corresponding portion of vertices within a second vertex region of the second surface model; matching the vertices of the first vertex region to the corresponding vertices of the second vertex region, calculating the distances between the vertices of the first vertex region to the corresponding vertices of the second vertex region; and rejecting the landmark if the distances exceeds a predefined threshold.

In the above embodiment the threshold is a difference of at most 1.0 mm between, more preferably 0.5 mm.

In some embodiments the landmark is registered through normal ray matching, comprising the steps of: selecting one or more vertices from the vertex regions of the first surface model, for each of the selected vertices, determining an intersection point by tracing the normal ray towards the corresponding vertex region of the second surface model; assessing the intersection by evaluating the dot product between the normal at the intersection point and the vertex region of the second surface model; and registering a potential landmark as the closest vertex to the intersection.

In some embodiments the landmark is registered through constraint satisfaction problem, comprising the steps of (1) selecting one or more vertices with the highest curvature of the plurality of vertices on the first surface model; (2) for each selected vertices, identifying a corresponding plurality of vertices with similar curvature on the second surface model; formulating a CSP including at least constrains representing the distance measurement between corresponding the selected vertices of the first surface model and the corresponding vertices of the second surface model; and registering a potential landmark between all vertices of the first surface model that closely approximate the distances between the corresponding pairs of vertices on the second surface model.

In some embodiments, comprising the steps of determining the size and/or volume of the plurality of surface models, and the selecting the surface model having the largest size and/or volume is selected as the first surface model, and preferably, selecting the surface model having the second largest size and/or volume as the second surface model.

In some embodiments the stopping condition comprises a convergence of the cost function.

In some embodiments the anatomical reconstruction is determined during the step of iteratively refining the reconstructed model.

In some embodiments the surface model is generated by generating a geometric model fully encompassing the identified fragment and iteratively shrinking said model until it approximates the shape of said fragment, preferably by applying a shrink-wrapping algorithm.

In some embodiments the landmark is assigned by determining a curvature of at least two surface models; and wherein the reconstructed model is generated by identifying regions having a substantially complementary curvature between said surface models, and aligning said surface models along said regions with complementary curvature.

In some embodiments the landmark is assigned by determining a curvature/straightness of at least two surface models; and wherein the reconstructed model is generated by identifying regions having a low curvature/straightness on said surface models, and aligning said surface models along said regions with low curvature/straightness.

In some embodiments the landmark is assigned by determining a distance between at least two surface models; and wherein the reconstructed model is generated by identifying points/regions of nearest distance between said surface models, and aligning said surface models along said points/regions of nearest distance.

In some embodiments the landmark is assigned by defining a normal ray based on a surface of at least one surface model; and wherein the reconstructed model is generated by identifying points of one or more surface models intersecting along said normal ray, and aligning said surface models along said intersecting points/regions; preferably wherein an angle between said intersecting point/region and the normal ray is at most 53.0°.

In some embodiments the surface model is a 3D model, wherein the landmark is assigned by splitting at least one surface model into a plurality of parallel 2D slices, and wherein the reconstructed model is generated by identifying points/regions of one or more surface models intersecting along at least one of said 2D slices, and aligning said surface models along said intersecting points/regions; preferably wherein the landmark is assigned by splitting at least two surface models into a plurality of parallel 2D slices, and wherein the reconstructed model is generated by identifying points/regions of intersecting 2D slices of at least two surface models, and aligning said surface models along said intersecting points/regions. In some embodiments an Oriented Bounding Box (OBB) is generated for at least two surface models, said OBBs having a centre and edges, and
wherein the reconstructed model is generated by aligning the centres of the OBBs of said surface models, and aligning said surface models along their corresponding OBBs.

Advantageously, the OBB is determined based on the most exterior points of a surface model such that all surface points are included inside the OBB box. This lowers the mismatching of surface models.] In some embodiments the cost function of the reconstructed model includes at least one of the following reconstruction metrics:
a total and/or partial distance between the surface models,
a normal direction between the surface models, and/or
a total and/or partial penetration depth of the surface models.

In some embodiments at least one surface model is tagged as a target and at least one surface model is tagged as a source; and wherein the reconstructed model is generated by repositioning said source to align with said target, preferably wherein the method comprises determining a size/volume of the surface models, tagging at least one surface model having the highest size as a target, and tagging at least one surface model having a lower size than said target object as a source.

In some embodiments, if the bone is broken into three or more fragments, at least one surface model is tagged as a target and at least two surface models are tagged as a source; and wherein the reconstructed model is generated by repositioning one or more sources to align with the plurality of surface models to obtain a joined source, and repositioning said joined source to align with said target, preferably wherein the method comprises determining a size/volume of the surface models, and repositioning the surface model based on size/volume, preferably in an ascending order, from the surface model having the lowest size to the surface model having the highest size.

In some embodiments the method comprising comparing the, preferably refined, reconstructed model with a reference model of an unbroken bone, and evaluating a difference metric that measures a difference between said reconstructed model and said reference model; preferably wherein the reference model comprises image data associated with an unbroken bone, preferably of the same subject, and/or wherein the reference model comprises a statistical shape model generated based on image data of a plurality of unbroken bones.

In some embodiments the method further comprises outputting the anatomical reconstruction of the broken bone to a user, preferably as a set of instructions as part of preoperative planning.

Another aspect of the present disclosure relates to a computer program product for implementing, when executed on a processor, a method in accordance with any one of the preceding claims when provided with image data as input, preferably from a medical imaging device.

Another aspect of the present disclosure relates to a system comprising a medical imaging device and a processor, wherein said medical imaging device is adapted for acquiring a plurality of medical images, and wherein said processor is adapted for receiving said medical images as image data and performing the steps of the method in accordance with any one of the embodiments as outlined herein.

### DESCRIPTION OF THE FIGURES

The following description of the figures relate to specific embodiments of the disclosure which are merely exemplary in nature and not intended to limit the present teachings, their application or uses.

Throughout the drawings, the corresponding reference numerals indicate the following parts and features: broken bone fragment (101); surface model (102); landmark (103); translation (104); rotation (105); slices (108); reconstructed model (110); apparatus (200); medical image (210); memory (210); processor (230).

FIG. 1 shows a flow diagram of the (computer-implemented) method for determining the anatomical reconstruction of a broken bone according to an embodiment of the present disclosure.

FIG. 2 demonstrates an implementation of the method depicted in FIG. 1 on an apparatus 200 according to an embodiment of the present disclosure.

FIG. 3 shows a flow diagram of the (computer-implemented) method for determining the anatomical reconstruction of a broken bone according to a preferred embodiment of the present disclosure. The method is discussed in more detail in Example 1.

FIGS. 4A-4C showcase exemplary images of three different fragmented radii used to evaluate the performance of the reconstruction algorithm presented in FIG. 3. These images are discussed in more detail in Example 2.

FIGS. 5A-5C illustrate an example of the processing of a bone fragment 101 into a surface model 102 based on the dataset of FIGS. 4A-4C. The preprocessing is discussed in more detail in Example 2.

FIGS. 6A-6D showcase an example of the alignment of surface models 102 with a reconstructed model 110 based on the dataset of FIGS. 4A-4C. The alignment process is discussed in more detail in Example 2.

FIG. 7A shows an exemplary image of bone fragments 101 at their initial positions.

FIG. 7B shows an exemplary anatomical reconstruction 110 by the reconstruction framework depicted in FIG. 3.

FIG. 7B shows an exemplary anatomical reconstruction 110′ by an orthopedic surgeon as comparative reference.

FIG. 8A shows a comparative distance map based on the anatomical reconstruction 110′ of FIG. 7C using the first dataset of FIG. 7A.

FIG. 8B shows a comparative distance map based on the anatomical reconstruction 110 of FIG. 7B using the first dataset of FIG. 7A.

FIG. 9A shows a comparative distance map based on the anatomical reconstruction 110′ of FIG. 7C using the second dataset of FIG. 7A.

FIG. 9B shows a comparative distance map based on the anatomical reconstruction 110 of FIG. 7B using the second dataset of FIG. 7A.

FIG. 10 presents an example of transformations used for anatomically aligning a surface model.

FIGS. 11A-11C show exemplary embodiments of how a 3D surface model can be sliced into a number of 2D slices 108, each figure depicting a different slicing direction within the 3D space.

FIG. 12 presents an example of how fracture line matching 381 can be used as a reconstruction metric 380 in the method presented in FIG. 3.

FIG. 13 presents an example of how a Constraint Satisfaction Problem (CSP) 382 can be used as a reconstruction metric 380 in the method presented in FIG. 3.

FIG. 14 presents an example of how the normal ray 383 can be used as a reconstruction metric 380 in the method presented in FIG. 3.

FIGS. 15A-15C presents examples of how different directions of fragment slicing 384 can be used as a reconstruction metric 380 in the method presented in FIG. 3, each figure depicting a different slicing direction within the 3D space.

### DETAILED DESCRIPTION

In the following detailed description, the technology underlying the present disclosure will be described by means of different aspects thereof. It will be readily understood that the aspects of the present disclosure, as generally described herein, and illustrated in the figures, can be arranged, substituted, combined, and designed in a wide variety of different configurations, all of which are explicitly contemplated and make part of this disclosure. This description is meant to aid the reader in understanding the technological concepts more easily, but it is not meant to limit the scope of the present disclosure, which is limited only by the claims.

The present disclosure introduces a technology that enhances the process of reconstruction of a broken object, more specifically, the herein disclosed technology relates to a method for (semi) automated determination of a structural reconstruction based on one or more images, and a system configured for the same. In some embodiments, the technology can be implemented for the reconstruction of a broken bone, more specifically, the herein disclosed technology relates to a method for (semi) automated determination of an anatomical reconstruction based on one or more medical images, and a system configured for the same.

For instance, in comparison to conventional techniques, the disclosed technology may reduce the resources required to obtain an anatomical reconstruction of a broken bone. Also, it can enhance the accuracy of such anatomical reconstruction by optimizing the alignment of the fractured bone fragments within a virtual reconstruction.

Furthermore, this technology has the potential to elevate the quality of medical procedures, particularly those involving the realignment of broken bones to their unbroken state. This can be achieved by providing information that can be used to enhance procedure planning or guidance, often in the form of a virtual reconstruction of the damaged bone. This improvement in medical procedures can lead to shortened recovery times for patients and a reduced risk of post-operative complications.

The technology disclosed herein can be considered a ‘general-purpose’ bone reconstruction technology. It can be readily adapted for various bone fractures and applications. This can include applications such as surgical fixation procedures or forensic reconstructions of broken bones, even across different populations, ages, sexes, and species (e.g., animals). It is important to note that this technology is not limited to specific bone fractures, as long as the bone can be examined using medical imaging technology, allowing for the acquisition of medical images of the bone fragments or parts thereof.

The technology disclosed in this document can also be considered a “general-purpose” object reconstruction technology. It can be easily adapted for reconstructing various types of object fractures and applications. This includes the restoration of broken objects found at archaeological sites, such as utensils (e.g., pots, vases, pitchers, etc.), architectural structures (e.g., columns, pillars, walls, arches, monuments, etc.), sculptures (e.g., statues, busts, tombs, etc.), artistic pieces, and more. It's important to note that this technology is not limited to specific types of fractures; rather, it can be applied as long as the object can be examined using imaging technology, allowing for the acquisition of images of the fragments or parts thereof.

Despite the aforementioned broad applicability, specific examples of bone fractures will be discussed to aid the understanding of the disclosed technology. In particular, the focus will be on distal radius fractures in human subjects, as they rank among the most common fractures treated in emergency departments and offer a relevant context for implementing the disclosed technology. However, it's important to note that the technology can be applied to various other scenarios, such as fractures of the femur, tibia, ulna, radius, rib, or any other bone, either individually or in combination. Additionally, while the medical images in the discussed examples are obtained through X-ray Computed Tomography (CT) scanners, it's worth appreciating that the disclosed technology is adaptable to any available medical imaging data or combinations thereof.

Furthermore, it's important to appreciate that the present technology is particularly well suited for in reconstructing complex bone fractures, particularly those associated with joint-related injuries in areas such as the shoulder, elbow, knee, and others. The method's versatility extends to accommodating bone fragments of varying numbers, sizes, and shapes, regardless of the intricacies of the fracture. This stands in contrast to conventional methods, which are often limited to addressing simpler fractures involving cylindrical or elongated bone fragments that align more easily along the length axis of the broken bone. In complex fractures featuring numerous small fragments with undefined shapes, the use of the length axis as alignment parameters is impractical, as the smaller fragments typically exhibit spherical shapes. Therefore, in effect, by way of the technology described herein, it is possible to use a (computer implemented) technique to determine a transformation that anatomically aligns fragments of the broken bone to obtain a reconstructed model representing an unbroken form of the bone. Thus, it is possible to determine (in a virtual way) a transformation that can be applied to one or more fragments of a broken bone to anatomically align the one or more fragments of the broken bone with one or more other fragments of the broken bone. In other words, the determined transformation can align the fragments of the broken bone into their correct positions to rearrange, reassemble and/or reconstruct the bone into an unbroken form. In this way, the manner in which to rearrange, reassemble and/or reconstruct a broken bone can be determined, which can be useful in planning or guiding a medical (for example, surgical) procedure for reassembling the broken bone.

As used herein, an “anatomical reconstruction” refers to a (computer-implemented) method for reconstructing a broken bone from two or more fragments of a subject in an anatomically accurate manner. In this context, a ‘fragment,’ when referring to the broken bone, denotes a portion of that bone that has become detached or broken off from its original shape. The subject in question can be a living entity, such as a patient, or a non-living entity, suitable for forensic analysis or archaeological studies (for example, anthropology). The subject whose bone is broken may be human, although applications involving non-human subjects (such as animals) are also within scope. The objective of the reconstruction is to return the broken bone fragments to their original shape and dimensions, or as close to it as functionally feasible, considering the complexity of the fracture (e.g., due to missing fragments or irreparably damaged parts). The anatomical reconstruction can be integrated as part of a broader procedure aimed at restoring the broken bone, for instance, as part of a medical (for example, surgical) procedure.

As used herein, an “structural reconstruction” refers to a (computer-implemented) method for reconstructing a broken object from two or more fragments in a structurally accurate manner. In this context, a ‘fragment,’ when referring to an object, signifies a part of that object that has become detached or broken off from its original shape. The object in question can take various forms, such as a component of a building, a utensil, an art piece, a sculpture, and more. The goal of the reconstruction is to return the broken fragments to their original shape and dimensions, or as close as functionally possible, accounting for the complexity of the fracture (e.g., due to missing fragments or irreparably damaged sections). As used herein “surface model” refers to a virtual representation, typically a mathematical model within a computer, of the surface of a fragment. This representation is defined by one or more geometric parameters stored in a data matrix. The surface model may undergo (pre) processing to approximate the ‘actual’ surface of the corresponding fragment, such as a bone or object, to facilitate easier reconstruction. The geometric parameters are often stored using points specified in a particular coordinate system (e.g., Cartesian), sometimes as a point cloud. The surface model can be a single 3D model or a series of 2D models that correspond to specific sections of the 3D model, referred to as ‘slices.’ Depending on the specific embodiment, either the 3D model or one of its 2D slices may be advantageous for determining information to refine the reconstructed model.

As used herein, “reconstructed model” refers to a virtual representation of the aforementioned anatomical or structural reconstruction of the broken bone or object, or a portion thereof. This representation is based on the transformation of one or more surface models. The reconstructed model may include a reconstruction matrix that specifies the transformation of the one or more surface models and/or the relative positions of each surface model. The reconstructed model can serve as an output suitable for post-processing, such as rendering in 3D on a user display.

An overview of various aspects of the technology of the present disclosure is given hereinbelow, after which specific embodiments will be described in more detail. This overview is meant to aid the reader in understanding the technological concepts more quickly, but it is not meant to identify the most important or essential features thereof, nor is it meant to limit the scope of the present disclosure. When describing specific embodiments, reference is made to the accompanying drawings, which are provided solely to aid in the understanding of the described embodiment.

An aspect of the present disclosure relates to a computer-implemented method for determining a structural reconstruction of a broken object, whereby said object is broken into two or more fragments; the method comprising:
receiving image data associated with the broken object;
identifying a plurality of fragments in said image data, generating a surface model for each identified fragment, defined by one or more geometric parameters, and assigning one or more landmarks to said surface models;
generating a reconstructed model of the broken object by repositioning one or more of the surface models, based on the landmarks, to align with the plurality of surface models;
iteratively refining the reconstructed model by changing the position of one or more of the surface models, and evaluating a cost function that measures how a reconstruction metric is affected by said change in position, until a stopping condition is satisfied,
determining an anatomical reconstruction of the broken object by associating the plurality of identified fragments with the corresponding surface model in the reconstructed model.

Another aspect of the present disclosure relates to a (computer implemented) method for determining an anatomical reconstruction of a bone broken into two or more fragments, the method comprising the steps of:
Identifying the plurality of bone fragments in the medical image data, generating a plurality of 3D surface models that virtually represent the bone fragments, including at least a first and a second surface model, and registering a plurality of landmarks matching the first to the second surface model. The registration of landmarks involves identifying a plurality of vertex regions on the first and the second surface models, wherein a vertex region comprises a plurality of vertices with comparable curvature and normal direction, and matching one or more vertex regions of the first surface model with one or more vertex regions of the second surface model in accordance with a predefined matching criterion.
Generating a reconstructed model that represents a reconstructed form of the broken bone by selecting at least two landmarks yielding the highest degree of correspondence; providing a reference model that represents an unbroken form of the bone; and positioning the second surface model to align with the first surface model at the selected landmarks using the reference model as a reference. Optionally, repeating the positioning for each of the plurality of surface models until all surface models are aligned at corresponding landmarks relative to the reference model.
Iteratively refining the reconstructed model by selecting one or more different landmarks, repositioning the second surface model to align with the first surface model at the different landmarks, and evaluating a quality measure that quantifies how the repositioning affects the quality of the reconstructed model, until a stopping condition is satisfied. The quality measure comprises comparing the reconstructed model to the reference model, thereby identifying one or more alignment discrepancies between the reconstructed model and the reference model, and assigning a score to the alignment discrepancies based on one or more reconstruction metrics.
Determining an anatomical reconstruction of the broken bone by comparing the position of the identified bone fragments in the medical image data with the position of the corresponding surface models in the reconstructed model.

Another aspect of the present disclosure relates to a computer program product for implementing, when executed on a processor, a method in accordance with any embodiment described herein when provided with image data as input, preferably from a medical imaging device.

Another aspect of the present disclosure relates to a system comprising a medical imaging device and a processor wherein said medical imaging device is adapted for acquiring a plurality of medical images of a (broken) bone, and wherein said processor is adapted for receiving said medical images as image data and performing a method in accordance with any of the herein described embodiments when provided with a plurality of medical images.

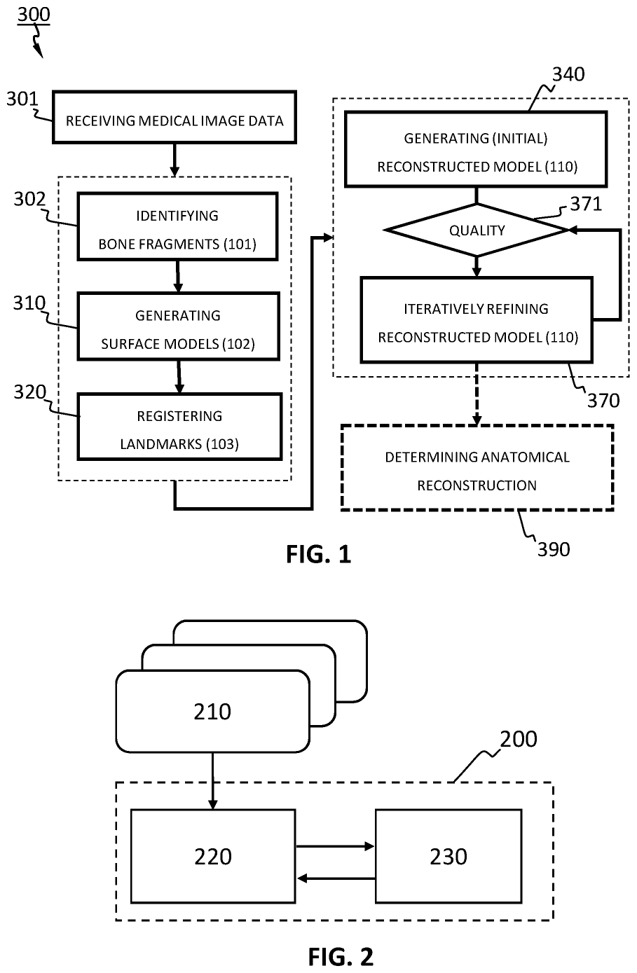

Another aspect of the present invention relates to a system comprising an imaging device and a processor wherein said imaging device is adapted for acquiring a plurality of images of a (broken) object, and wherein said processor is adapted for receiving said images as image data and performing a method in accordance with any of the herein described embodiments when provided with a plurality of images. A general embodiment of the present technology will be discussed with reference to FIG. 1. This figure schematically depicts a flow diagram of a (computer-implemented) method 300 for determining the anatomical reconstruction of a bone that has fractured into two or more bone fragments. It is understood that additional steps can be provided before, during, and after the steps of the method, and that some of the steps described can be replaced or eliminated for other implementations of the method.

For the sake of clarity in understanding this disclosure, the description will portray the method of FIG. 1 as if it were performed by a processor within a medical imaging system. However, it's worth noting that the method can be executed by any other appropriately configured processor, such as that of a personal computer, if configured accordingly. Typically, the method can be executed by or under the control of a processor housed within a computing unit, which may be the computing unit of a system as described in this disclosure. Depending on specific embodiments, the method can be partially or fully automated.

As further shown in FIG. 2, the method can comprise the step of receiving image data associated with a broken bone. This image data, which may have medical origins, could be obtained from a medical imaging device, such as the one illustrated as a medical imaging device 200. In the embodiments discussed here, the medical image 110 can take the form of either a two-dimensional (2D) or three-dimensional (3D) image. Medical images can encompass various types, including but not limited to computed tomography (CT) images, such as those from a CT scan (e.g., C-arm CT images, spectral CT images, or phase contrast CT images), X-ray images (e.g., from an X-ray scan), magnetic resonance (MR) images (e.g., from an MR scan), or any other type of medical image pertinent to a broken bone. For example, in an embodiment where the image data is derived from a CT scan, a processor 230 might obtain the CT image of the subject's fractured bone from a CT scanner with which it can communicate. The medical image data may encompass at least one medical image, possibly a projection image, but it is particularly advantageous when it includes multiple medical images, such as 64-, 128-, or other slice configurations.

In some embodiments, the image data may be stored in the memory of a computing system, whether locally or remotely. This memory could be part of a database, a server, or any other storage facility. For instance, the processor 230 might retrieve the image of the subject's fractured bone or object from this memory. It's preferable for the medical image data to be stored in a format that's suitable for processing by the processor or can be readily converted into such a format. In some embodiments, the image of the fractured bone or object may be stored in a memory, which could be a memory associated with a database, server, or any other storage component. As an example, the processor 230 could fetch the image of the fractured bone or object from this memory. This memory might be either an integral part of the apparatus or an external memory source.

Returning back to FIG. 1, it is shown that the method begins at step 301 by receiving medical image data of a broken bone. The method comprises a pre-processing of the received medical image data to identify 302 a plurality, i.e., two or more, of bone fragments 101 from the broken bone 104, generate 310 a plurality of surface models 102 based on the identified bone fragments 101, and register 320 one or more landmarks 103 to the generated surface models 102. Hence, the provided image data is processed to generate data that can be fed as input to the reconstruction algorithm, which will be explained in more detail later.

The image data pre-processing steps may be performed by a processor 102 of an apparatus 100, for example, of the medical imaging device shown in FIG. 2. For example, the processor 230 may be configured to receive the image data from a medical imaging device 200 and process said received image data to identify the bone/object fragments 101, generate the surface models 102, and assign the landmarks 103. The generated data may be stored on a memory 220 of the medical imaging device 200. Generally speaking, the objective of the image data pre-processing is to adapt the image data in a way that that advantageously optimises the generation and refinement of the reconstructed model, for instance, by improving the accuracy of the reconstruction and/or by reducing the complexity of the computations. Hereinunder various embodiments are described that can improve one or more aspects of the disclosed method. However, the skilled person understands that various (image) processing techniques may be contemplated, and although examples are provided, the present technology is not limited to the herein discussed embodiments.

In some embodiments, the bone/object fragments may be recognised using an image recognition algorithm that (automatically) recognises bone/object tissue in the image data, based on one or more imaging parameters, and determines their general properties, e.g. position and size. The image recognition is dependent on the parameters used for acquiring the medical image, such as the CT-scanner configuration. For instance, bone/object tissue is typically denser than other types of (soft) tissue and, therefore, can be distinguished based on the attenuation of the X-ray radiation. Additional information may be included to improve the accuracy of the image recognition accuracy, such as prior knowledge of the bone/object type and location, which can be input by a user via a user interface or (automatically) detected via a detection algorithm.

As mentioned earlier, the image data comprises an image of the different fragments of the broken bone/object. Thus, the image data at least comprises two or more different bone/object fragments for the anatomical/structural reconstruction of the bone/object. However, it will be appreciated that a single image may not necessarily comprise the entire bone/object and may, for example, only comprise the portion of the broken bone/object that contains the fracture and/or one or more bone/object fragments. For instance, in a fracture of a joint it may be beneficial to include only relevant image data, such that no resources are spent on identifying nonfractured bone/object fragments.

In some embodiments, a selection of bone/object fragments can be made during or after image data processing. For instance, fragments that are too small or too narrow for a reconstruction procedure may be excluded from identification. The excluded bone/object fragments may be annotated so that a user evaluating the reconstructed model can be informed about these fragments. For instance, a decision can be made to remove the excluded fragments during performing the procedure. Alternatively or in combination, the exclusion may be based on a set of predefined parameters, such as shape, size, density, and so on.

As mentioned earlier, after identifying the bone/object fragments, a surface model is generated for each one of the identified bone/object fragments. Thus, the method comprises the generating of at least two or more different surface models. In some embodiments, the generated surface model of the corresponding bone/object fragment can comprise a mesh generated using an image-based meshing approach. For instance, a surface reconstruction of the identified model can be realized by combining geometric detection and mesh creation stages. Thus, in these embodiments, the acquired mesh may be a mesh that is derived based on one or more image processing algorithms.

In some embodiments, the generated surface model can comprise a plurality of segments. The segments can be any shaped polygon and thus the mesh can be any shaped polygon mesh. For example, the segments can be triangular shaped segments and thus the mesh can be a triangular mesh. However, although an example is provided, it will be understood that any other shaped segments are possible and thus any other shaped mesh is also possible, for example, tetrahedron, pyramid, triangular prism, hexahedron, Polyhedron, and so on. In an example, the surface model of the corresponding bone/object fragment can comprise a surface mesh representing typical anatomical/structural shapes of the corresponding bone/object fragment and optionally also volumetric information such as (for example, spatially encoded) trabecular density and orientation information, which will be explained in more detail later.

As mentioned earlier, the generation of a surface model comprises a determining of one or more (geometric) parameters of the bone/object fragments that define the generated surface model. The determined parameters are relevant for determining the transformations (e.g. repositioning) that are permitted and preferred when anatomical/structurally reconstructing the reconstructed bone/object model. The parameters may relate to the bone/object fragment as a whole, for instance, shape and size, or specific points/portions of the bone/object fragments, which may, for instance, function as landmarks to guide the reconstruction algorithm.

For example, in some embodiments, the at least one (geometric) parameter can define an upper limit on the extent to which a surface model is transformable. For instance, the least one parameter can define one or more directions and/or dimensions in which the model is translatable and/or rotatable. Hence, in embodiments where the at least one parameter defines an upper/lower limit on the extent to which the position of a portion of the model is transformable, e.g. in a certain direction and/or dimension. Alternatively or in addition, the at least one parameter can define an upper/lower limit on the extent to which the position of a portion of the surface model is transformable with respect to another surface model.

According to any of the embodiments described herein, the at least one parameter that defines one or more permitted deformations to the model can, for example, be set according to at least one characteristic of the corresponding bone/object fragment. The at least one characteristic may comprise, for example, a range for the size of the corresponding bone/object fragment, a general morphology of the corresponding bone/object fragment, a range for a distance to another bone/object fragment, or any other characteristic, or any combination of characteristics, of the one or more bone/object fragments. For example, the upper limit described earlier may be defined (or set) based on maximum and minimum. The at least one parameter thus ensures that any transformation (e.g. translation and/or rotation) that is made to the generated surface model in the reconstruction process, which will be described later, is consistent with the corresponding bone/object fragment bone/objects and is thus reasonable.

As mentioned earlier, the generated surface model can be a mesh that approximates the surface of the corresponding bone/object fragment. However, the surface of bone/object fragments may contain redundant information, such as grooves or trabecular structures, that is not required for the reconstruction algorithm and hence would take up the computing resources. Therefore, it may be advantageous to generate a mesh in which such redundant information is at least partially omitted. For instance, the surface model can be generated by approximating the global shape of the bone/object and/or the generated surface model can be adapted by removing (redundant) variations. Thus, the adapted surface model allows a reconstruction of the broken bone/object based on the global shape of the bone/object fragments.

In some embodiments, the surface model can be generated by defining an initial model that fully encloses the corresponding bone/object fragment, and iteratively deforming the initial model until it approximates the global shape of said fragment. The initial model can be of any geometry fitting the dimensions of the corresponding bone/object fragment, such as a sphere, cuboid, prism, and so on. For example, a spherical mesh fully encompassing all of the points identified on the surface of the corresponding bone/object fragment. Advantageously, the initial size of the initial model may be based on two points on the surface of the corresponding bone/object fragment that are spaced apart the most, for instance, to define a diameter of the initial model. Next, a deformation is applied in order to let the edges of the initial model, such as the spherical mesh, gradually adjust to the global shape of the corresponding bone/object fragment. For instance, one or more edges of the initial model may be moved towards the surface of the bone/object fragment until a condition is satisfied, such as a partial overlap of one or more points of the initial model with the correspond bone/object fragment. However, although an example is provided, it will be understood that any other shaped initial models are possible.

In any of the above-described embodiments, the initial model can be gradually shrunk to approach the shape of the corresponding bone/object fragment, for instance, by decreasing the distance between two or more spaced apart mesh points until the deformed initial model approaches a point or portion of the surface of the corresponding bone/object fragment. Optionally, the surface of the deformed geometric model may partially overlap with the surface of the corresponding bone/object fragment. In this way, a smooth approximation of the bone/object fragment surface can be generated. Thus, a surface model can be generated based on the global shape of the bone/object with a relatively smooth surface.

In some embodiments, the surface of the generated surface model may be smoothed to remove one or more variations, preferably by applying one or more filters onto the surface model. As mentioned earlier, the surface of bone/object fragments may contain redundant information that is not required for the reconstruction algorithm. Additionally, the surface of a surface model that has been adapted to approximate the global shape of the bone/object, for instance by applying the above-described embodiment, may have erroneous wrinkles or folds that are caused by the deformation. Therefore, it may be advantageous to smoothen the surface of the generated surface model, thereby removing any such wrinkles or olds.

For example, if the surface model is a mesh, the segments of said mesh can be smoothed to reduce variation between them. Additionally or in combination, the smoothing may comprise a detecting of a variation in the surface of said model and changing the value of said variation to approximate. For instance, a variation may be a maxima/minima point that results in a peak/depression on said surface model, in which case the surface model can be deformed by adjusting the value of said maxima/minima to a value of nearby e.g. adjacent points.

Thus, for example, the initial mesh may be processed through cartesian wrapping (voxelization), mesh transformation to adapt to the geometry of the bone/object fragments (projection), as well as mesh quality optimizations (refinement) to refine the mesh surface.

As further shown in FIG. 1, information about a bone/object fragment may be determined and registered 320 as a landmark 103 to the corresponding surface model.

As used herein, a “landmark” refers to a point within the bone or object fragment that holds anatomical or structural significance. Landmarks can be unequivocally defined and consistently located with a high degree of precision and accuracy. The relative positions of multiple landmarks collectively form a spatial map representing the arrangement of features they signify. Landmarks may be associated with geometric characteristics of the surface model, such as points with high curvature or extreme points. They may also relate to geometric attributes connecting two or more surface models, such as complementary curvature points or nearest points. While the examples of suitable landmarks are outlined below, it's essential to understand that other types of landmarks may also be considered. The present technology is not restricted to a particular category of landmarks. Advantageously, the method can determine landmarks through automatic pattern recognition, although users may also manually annotate landmarks as needed. Advantageously, a selection of landmarks is made based on their potential relevance for the reconstruction algorithm. The surface of bone/object fragments may a very large number of landmarks, some of which may be redundant for the reconstruction algorithm. For instance, landmarks located in portions of the bone/object fragment that are distant from the fracture are less likely to be relevant than landmarks located at or near the fracture. Therefore, in one embodiment a landmark may be given a weight that decreases the further away it is located from the fracture. In another embodiment a landmark may be given a weight that decreases based on the orientation (e.g. angle) relative to the fracture. Alternatively or in combination, a cut-off can be made based on the potential relevance, for instance, by omitting any landmark located past a specific distance from the fracture and/or outside a specific orientation relative to the fracture.

In some embodiments, the landmark may comprise information about the positioning of a bone/object fragment relative to another, e.g. second, bone/object fragment, such as a spatial feature. Examples of a spatial feature include, but are not limited to, a distance and/or an orientation of a surface feature of the corresponding bone/object fragment to a reference feature, for instance, a point/portion of the other, e.g. second, bone/object fragment, for example, the fracture line. In these embodiments, for example, the determined transformation may be adjusted to align the reference feature in two or more of the fragments.

In some embodiments, the landmark may comprise information about the proximity of at least two bone/object fragments. Displacement of bone/object fragments caused by a fracture is typically limited in space due to the presence of nearby (soft) tissue; therefore, nearby located fragments and more specifically the nearest portion of such nearby located fragments are more likely to match. Accordingly, in any of these embodiments, the method may comprise a determining of a distance between at least two bone/object fragment, for instance based on single points or an average distance between portions of the bone/object fragments, and identifying landmarks representing the nearest distance between them. The distance may be determined based on a single point, for instance, the nearest distance between two points of the bone/object fragments, or on a region, for instance, the nearest distance between two portions of bone/object fragments, for example, determined based on an average distance of all points contained in said two portions of the bone/object fragments.

In some embodiments, the landmark may comprise information about a distance and/or orientation (e.g. angle) from a surface normal defined at a point of a reference bone/object fragment, i.e., a line perpendicular to the tangent plane of the surface of a reference bone/object fragment. Preferably, the normal is defined at a point in a portion of the bone/object fragment that likely corresponds with the location of a fracture. Displacement of bone/object fragments caused by a fracture is typically limited due to the presence of nearby (soft) tissue; therefore, a bone/object fragment located along the surface normal of a reference bone/object fragment is more likely to match. Similarly, the rotation of bone/object fragments is typically limited also; therefore, the portion of a bone/object fragment located along the surface normal of a reference fragment is more likely to match with the portion of the reference fragment from which the normal is defined. Nonetheless, some displacement or rotation of a bone/object fragment may still be expected, for instance, due to post-fracture movement; hence, both the distance and orientation from the surface normal may advantageously be taken into consideration. Accordingly, in any of these embodiments, the method may comprise a defining a (surface) normal based on an of a reference bone/object fragment, and identifying landmarks on representing the nearest distance and/or lowest orientation to said normal, for instance, a point/portion of another bone/object fragment that intersect along said normal. Alternatively, the landmark may comprise information about the angle of incidence of a point/portion of a bone/object fragment relative to the normal, i.e., the angle that the incident ray makes with the normal ray, for example, 0 degrees. Advantageously, a limit between said intersecting point/region and the normal is set at an angle of most 53.0°, i.e., a dot product of 0.6. Angles outside this limit are unlikely to match.

In some embodiments, the landmark may comprise information about the curvature of the bone/object fragment. As used herein a “curvature” with reference to a bone/object fragment refers to the degree by which a surface of said fragment deviates from being a plane, for instance, when considering the global shape or a specific portion thereof. One way to determine how much a surface deviates is to look at the curves of the bone/object fragment relative to a particular coordinate system. Bone/object fragments having a similar curvature are more likely to match, for instance, in the case of nonlinear fractures. Accordingly, in any of these embodiments, the method may comprise a determining of a curvature of at least two bone/object fragments, for instance, based on their global shape or particular portions thereof, and identifying a landmark representing a substantially complementary curvature. The complementary curvature can be determined based on a standard deviation of all points in the portion, for instance, a standard deviation of 3 or less, preferably 2 or less, more preferably 1 or less. Additionally or in combination, the curvatures may be determined based on the corresponding surface models because they have a smoother surface that better approximates the global curvature.

In some embodiments, the landmark may comprise information about the straightness (i.e., low curvature) of the bone/object fragment. Bone/objects typically have a curved surface, therefore, a portion of a bone/object fragment having a very low curvature (e.g. near linear) is more likely to correspond to the fracture. Hence, bone/object fragments having a similar straightness are more likely to match. Accordingly, in any of these embodiments, the method may comprise a determining of a straightness of at least two bone/object fragments, for instance, based on their global shape or particular portions thereof, and identifying a landmark representing a substantially complementary straightness. The complementary straightness can be determined based on predefined values, for instance, a portion of the fragment in which all points are uniform, advantageously spanning a minimum distance of the fragment, or based on relative values, for instance, by comparing the deviation of adjacent points in a specific portion of the fragment.

In any of the above embodiments, the landmark may be assigned by splitting at least one surface model into a plurality of, preferably parallel, 2D slices, and wherein the reconstructed model is generated by identifying points/portions of one or more surface models intersecting along at least one of said 2D slices, and aligning said surface models along said intersecting points/portions.

For example, FIG. 11A show an example of a first surface model 102 corresponding to a first broken bone/object fragment and a second surface model 102′ corresponding to a second broken bone/object fragment. To improve the alignment of the first surface model 102 relative to the second surface model 102′, the first surface model 102 can be split into a plurality of 2D slices. For example, in FIG. 11B the first surface model 102 is split into a plurality of parallel 2D slices 108 along a first axis, in the provided example, a vertical axis. In another example, in FIG. 11C the first surface is split into a plurality of parallel 2D slices 108 along another axis, in the provided example, a horizontal axis. It is understood that the embodiments of FIGS. 11B and 11C are exemplary in nature and any alignment or axis can be used to generate slices, or even combinations thereof, for example, a combination of FIGS. 11B and 11C. In some embodiment the landmark is assigned by splitting at least two surface models into a plurality of, preferably parallel, 2D slices, and wherein the reconstructed model is generated by identifying points/regions of intersecting 2D slices of at least two surface models, and aligning said surface models along said intersecting points/regions. Accordingly, more complex 3D problems can thus be reduced to a number of layered 2D problems.

In an embodiment the number of 2D slices is defined for the smallest dimension (x, y or z). The number of slices for the remaining two dimensions (i.e., y or z, or alternatively, x or y, o) is calculated such that the distance between two 2D slices is the same in every dimension.

Thus for example, if the number of 2D slices is 5, preferably 10. This advantageously enables the segmentation to effectively lower the complexity of the problem, de facto lowering the effort required by the computing unit, as well as providing sufficient spatial resolution.

Returning to FIG. 1, it is shown that the method further comprises a generating 340 of an initial reconstructed model 110 by transforming the surface models 102 to anatomically align. The surface models 102 are initially not aligned relative to each other, but instead are spaced apart in the particular coordinate system. Hence, a course alignment is first performed between corresponding portions of the surface models 102. The objective of the initial reconstruction is, therefore, not to generate an “optimal” anatomical reconstruction, i.e., in which the surface models are optimally aligned, but rather to generate a framework by which a refinement algorithm can optimise the anatomical reconstruction, which will be explained in more detail later.

The transformation that is determined to anatomically/structurally align the surface models 102 may be determined by a processor 230 of an apparatus, for example, of the medical imaging device 220 shown in FIG. 2. For example, the processor 230 may be configured to download the generated surface models 102 from the memory 220, which includes corresponding information about said models, such as the (geometric) parameters and landmarks 103, and calculate the transformation necessary for aligning the surface models 102 into an initial reconstructed model 110. The generated reconstructed model and information about the calculated transformations, such as the transformation parameters, may be stored on the memory 220, temporarily or permanently, depending on the application.

The transformation that is determined to anatomically/structurally align the surface models may comprise a translation of one or more surface models, a rotation of one or more surface models, or a combination thereof, such as a translation of one surface model and a rotation of another, e.g. second, surface model. The transformation thereby essentially corresponds to a repositioning of a surface model in the particular coordinate system. Therefore, a transformation comprising a translation and/or rotation of a surface model is referred to hereinbelow as a “repositioning” of said model or part thereof in a way that a reconstructed model of the broken bone/object can be generated. The transformation can be specified in a transformation matrix comprising the coefficients for modifying and repositioning the model from one position to another. Each type of transformation may advantageously be specified in a separate matrix, e.g., a translation matrix, a rotation matrix, and so on.

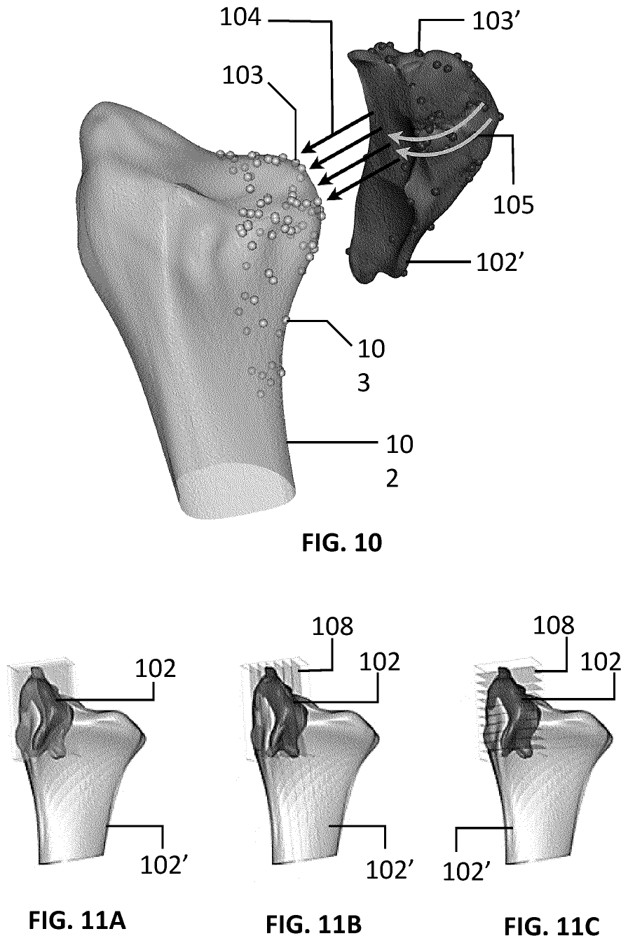

An example of the transformations to anatomically align a surface model is shown in FIG. 10. In the shown example, a first surface model 102 (the target) is fixed in position as and a second surface model 102′ (the source) is transformed to align with a portion of the surface of the first surface model 102. Specifically, a rotation 105 of the second surface model 102′ relative to the first surface model 102 is performed to align the matched portions of the surface models, and a translation 104 of the second surface model 102′ towards the first surface model 102 to fit the surface models together. The surface portions of the first surface model 102 and the second surface model 102′ are matched based on the identified landmarks 103.

The transformation that is determined to anatomical/structurally align the surface models may be determined from the transformations necessary to match specific portions of two or more surface models. The transformation necessary to match a portion of a first surface model to a corresponding portion of another, e.g. second, surface model may be, for example, a transformation from an initial position (e.g. translation) and/or orientation (e.g. rotation) of the first surface model to a final position and/or orientation of said surface model to fit a portion of the other, e.g. second, surface model, preferably along the matched portions.

For example, the transformation that anatomical/structurally aligns a portion of a surface model with a matched portion of another, e.g. second, surface model may be determined to be of the same magnitude as the transformation that is necessary to fit the portion of said surface model with the matched portion of the other surface model. Alternatively or in combination, the transformation that anatomical/structurally aligns a surface model with a matched portion of another, e.g. second, surface model may be determined to be the reverse (or inverse or opposite) of the transformation that is necessary to fit the portion of said surface model with the matched portion of the other surface model. Thus, for example, where the transformation necessary to fit a portion of a surface model to a matched portion of another, e.g. second, surface model, involves a translation in a particular direction, the transformation that anatomical/structurally aligns the surface models may be determined to be a translation of the same magnitude but in the opposite direction. Similarly, where the transformation necessary to fit a portion of a surface model to a matched portion of another, e.g. second, surface model, involves a rotation in a particular (e.g. clockwise), the transformation that anatomical/structurally aligns the surface models may be determined to be a rotation of the same magnitude but in the opposite direction (e.g. anticlockwise).

In any of the above embodiments, the transformation that anatomical/structurally aligns a portion of a surface model with a matched portion of another, e.g. second, surface model may be determined by fixing the position and/or orientation of at least surface model and calculating one or more transformation necessary for matching a portion of a nonfixed (i.e., transformable) surface model to a corresponding portion of the fixed surface model. Specifically, the at least one fixed surface model may be regarded as a “target” and at least one nonfixed surface model may be regarded as the “source”, that is transformable relative to the target. In this way, the calculations for determining the transformation may be simplified. In any of the above embodiments, the transformation that anatomical/structurally aligns a portion of a surface model with a matched portion of another, e.g. second, surface model may be determined based on a partial transformation of each surface model. Thus, for example, where the transformation necessary to fit a portion of a surface model to a matched portion of another, e.g. second, surface model, involves a translation of a particular magnitude in a particular direction, the transformation that anatomical/structurally aligns the two surface models may be determined to be a partial translation of the first surface model in one direction and a partial translation of the second surface model in the opposite direction, such that the combination of each partial translation corresponds to the total translation necessary to fit the portion of said surface model with the matched portion of the other surface model.

The matching of portions of two or more surface models to determine a transformation to anatomical/structurally align the surface models may, for instance, be based on the parameters (e.g. geometric or spatial) of the corresponding bone/object fragments that define the generated surface model and/or on landmarks assigned to the surface models based on information (e.g. geometric or spatial) derived from the corresponding bone/object fragments. Hereinunder various embodiments are described for determining a transformation to anatomical/structurally align the surface models. However, the skilled person understands that various alignment techniques may be contemplated, and although examples are provided, the present technology is not limited to the herein discussed embodiments.

In some embodiments, the transformation that anatomical/structurally aligns the surface models may be determined based on proximity of the corresponding bone/object fragments. As previously explained, nearby located portions of fragments are more likely to match. Accordingly, in any of these embodiments, the method may comprise a determining of portion of a surface model that represents the nearest distance between the corresponding bone/object fragments, and transforming at least one surface model to align along said portion of nearest distance.

In some embodiments, the transformation that anatomical/structurally aligns the surface models may be determined based on a distance and/or orientation of a bone/object fragment to a surface normal defined at a point on a reference bone/object fragment. As previously explained, portions of surface models located along the normal are more likely to match with the portion of the reference bone/object fragment from which the normal is defined, for instance, if the normal is defined on a portion corresponding to the location of the fracture. Accordingly, in any of these embodiments, the method may comprise a determining of portion of a surface model that intersects with the normal defined on a portion of a reference surface model, and transforming at least one surface model to align along said intersecting portion.

In some embodiments, the transformation that anatomical/structurally aligns the surface models may be determined based on a complementary curvature between the corresponding bone/object fragments. As previously explained, portions of bone/object fragments that have a similar curvature are more likely to match. Accordingly, in any of these embodiments, the method may comprise a determining of portion of a surface model that represents a complementary curvature between the corresponding bone/object fragments, and transforming at least one surface model to align along said portion of complementary curvature.

In some embodiments, the transformation that anatomical/structurally aligns the surface models may be determined based on a complementary straightness (i.e., low curvature) between the corresponding bone/object fragments. As previously explained, portions of bone/object fragments that have a similar straightness are more likely to match. Accordingly, in any of these embodiments, the method may comprise a determining of portion of a surface model that represents a complementary straightness between the corresponding bone/object fragments, and transforming at least one surface model to align along said portion of complementary straightness.

Thus, in the manner described above, a transformation can be determined that anatomical/structurally realigns the surface models corresponding to the bone/object fragments with each other. Although some simple examples have been provided for the manner in which the transformation is determined, it will be understood that the transformations necessary to fit the matched portions of surface models and thus also the transformations necessary to anatomical/structurally align the bone/object fragments of the broken bone/object can be more complex when applied to a clinical fracture, but the same general principles described above apply.

In this regard, in any of the above embodiments, the transformation has been described based on an anatomical/structural alignment of the matched portions of two surface models. However, although such a transformation may be sufficient to anatomical/structurally align a broken bone/object caused by simple fracture, i.e., in which the bone/object is broken in a small number of bone/object fragments, such as two or three fragments, it will be understood that that a clinical fracture may require a more complex transformation of a greater number of bone/object fragments, such as four, five or more still. Also, the manner in which the bone/object is broken may vary, for instance, a plurality of bone/object fragments may break off from a single larger bone/object at different fracture points, or in another exemplary scenario, one larger bone/object fragment may break off from another bone/object fragment, and subsequently shatter into any number of smaller bone/object fragments.

In any such scenario, the method may be adapted to perform a partial reconstruction, in which a limited number of surface models corresponding to a selection of bone/object fragments are realigned to generate a partially reconstructed model, that then can be realigned as a whole with any of the remaining surface models corresponding to the non-selected bone/object fragments, until a (fully) reconstructed model is generated. In this manner, the complexity of the anatomically/structural reconstruction can be reduced to a number of simpler transformation. Each partially reconstructed model can be refined separately or together as part of the (fully) reconstructed model.

In some embodiments, the sequence of the transformations that anatomically/structurally aligns a selection of surface models may be determined based on a size/volume of the corresponding bone/object fragments. Larger bone/object fragments contain more information for the reconstruction algorithm; therefore, the transformation that anatomically/structurally aligns the surface models of the largest bone/object fragments is more likely to result in a better alignment accuracy. Accordingly, in any of these embodiments, the method may comprise a determining a size/volume of the plurality of bone/object fragments, selecting the surface models corresponding to the largest bone/object fragments, and determining a transformation that anatomically/structurally aligns said selected surface models into a partially reconstructed model. These embodiments may be repeated iteratively, preferably in a descending order, i.e., from the largest to the smallest bone/object fragments, until every selected surface model has been anatomically/structurally aligned into a (fully) reconstructed model.

In some embodiments, the sequence of the transformations that anatomically/structurally aligns a selection of surface models may be determined based on a proximity of the corresponding bone/object fragments. As previously explained, nearby located portions of bone/object fragments are more likely to match. Accordingly, in any of these embodiments, the method may comprise a determining a distance between the plurality of bone/object fragments, selecting the surface models corresponding to the smallest distances, and determining a transformation that anatomically/structurally aligns said selected surface models into a partially reconstructed model. These embodiments may be repeated iteratively, preferably in an ascending order, i.e., from the smallest to the largest distances, until every selected surface model has been anatomically/structurally aligned into a (fully) reconstructed model.

In any of the above embodiments, a transformation may be determined to anatomically/structurally align a portion of the partially reconstructed model, consisting of two or more anatomically/structurally aligned surface models, with a portion of another, e.g. third, surface model. Advantageously, the transformation is determined for the partially reconstructed model as a whole to reduce computational complexity. In such embodiment, a new model may be generated, that corresponds to the combination of anatomically/structurally aligned surface models of said partially reconstructed model.

For example, an “Oriented Bounding Box” (OBB) may be generated based on the at least two anatomically/structurally aligned surface models. Advantageously, the dimensions of the OBB are based on the exterior points of the anatomically/structurally aligned surface models off said partially reconstructed model to ensure that the OBB fully covers the surface models. This decreases the mismatching of another, e.g. third, surface model with the OBB. The dimensions of the OBB are defined by the centre and edges, and advantageously the OBB is generated by aligning the centres of the aligned surface models. For example, the smaller surface models may be individually translated towards the centre of a larger surface model to a limited extent, since the corresponding bone/object fragments are typically torn apart and away from the centre of a larger bone/object fragment.

In any of the above embodiments, the transformation that anatomically/structurally aligns a portion of a surface model with a matched portion of another, e.g. second, surface model may be determined by fixing the position and/or orientation of at least surface model and calculating one or more transformation necessary for matching a portion of one or more nonfixed (i.e., transformable) surface models to a corresponding portion of the fixed surface model. Specifically, the at least one fixed surface model may be regarded as a “target” and any number of nonfixed surface models may be regarded as the “source”, that are transformable relative to the target. In this way, the calculations for determining the transformation may be simplified.

Returning yet again to FIG. 1, it is shown that the method further comprises an iterative refining 370 of the (initial) reconstructed model 110 by adjusting the transformation of the (coarsely) aligned surface models 102. As mentioned before, the surface models 102 are first coarsely aligned along the corresponding portions of the surface models 102, therefore, errors in alignments can be expected in the (initial) reconstructed model. Hence, by iteratively adjusting the transformation of the surface models 102 based on new information, for example, about the alignment quality, a smoothness between the aligned portions of the surface models 102 can be realised. Therefore, after each adjustment to the transformation of the aligned surface models 102, the refined reconstructed model can be reevaluated to determine to which degree the adjustment has improved the anatomical/structural reconstruction, for instance, based on a reconstruction metric.

The adjustment to the transformations that is determined to refine the alignment of the surface models 102 may be determined by a processor 230 of an apparatus 220, for example, of the medical imaging device shown in FIG. 2. For example, the processor 230 may be configured to download the generated (initial) reconstructed model 110 from the memory 220, which includes corresponding information about said reconstructed model 110, such as the cost function calculated for the current iteration of said model 110, and calculate the adjustments to the transformations necessary for refining the alignment of the surface models 102 towards a refined reconstructed model 110.

After each iteration, the refined reconstructed model 110 and information about the calculated adjustments to the transformations, such as the transformation parameters, may be stored on the memory 220, temporarily or permanently, depending on the application. Moreover, after each iteration, the processor 230 may be configured to calculate a new cost function for the reconstructed model 110, until a predetermined stopping condition is met, at which point the most “optimised” reconstructed model 110 may be selected from any iteration of the refined reconstructed models 110 based on a particular metric, for instance, the lowest cost function, and be stored on the memory 220 as the final reconstructed model 110.

The reconstructed model may be evaluated based on a mathematical (e.g. machine learning) model, referred to hereinbelow as the “cost function” or alternatively “loss function”, that is configured to assess the performance of the anatomical/structural reconstruction algorithm based on one or more reconstruction metrics. Generally speaking, the cost function evaluates how “wrong” the (refined) alignment of the surface models is in terms of its ability to generate an accurate reconstructed model, which may be, for instance, expressed by one or more reconstruction metrics that assign a “cost” to a selected parameter, for instance, a distance between the aligned surface models or a penetration depth of a partially misaligned surface model.

The objective of the iterative refinement of the reconstructed model, therefore, is to transform one or more models in a way that minimises the cost function based on the changes to the reconstruction metrics. As the reconstructed model is refined, the cost function will gradually converge towards a minimum where further changes to the positions of the one or more of the surface models produces negligible or zero changes in the loss—also referred to as ‘convergence’ of the cost function. For example, when a number of iterative refinement steps do not reduce the cost function further, the cost function has been converged.

The above-described refinement algorithm may run indefinitely, i.e., it will continue adjusting the transformation of the aligned surface models until stopped by an external input. Therefore, a stopping condition may be advantageously implemented to force the algorithm to terminate the refinement process once a desired outcome has been produced. The stopping condition can be any meaningful condition, such as number of iterations, quality of solutions, statistical values, and so on.

In some embodiments, the convergence of the cost function may be implemented as a stopping condition for the anatomical/structural reconstruction. This is a particularly meaningful condition for conserving computing resources when no statistically relevant improvement is being carried out by the refinement algorithm. Nonetheless, other stopping conditions may be implemented as an alternative or in combination. For example, the stopping condition may comprise a predefined number of refinements, for example, 100 iterations, 1 000 iterations, 10 000 iterations, and so on. This ensures that an anatomical/structural reconstruction can be generated within a predetermined amount of time, irrespective of the fracture complexity. In another embodiment, the stopping condition may comprise detecting a local minimum of the cost function. This approach could allow for the iterative refinement process to be terminated sooner, thereby saving computing resources before convergence can be detected. However, it requires the implementation of a reference model or dataset, as will be explained in more detail later.

As mentioned before, the cost function is calculated based on how a metric, referred to hereinbelow as “reconstruction metric”, is affected by an adjustment to the transformations of the aligned surface models. The adjustment to the transformation of the aligned surface models may cause a change in the anatomical/structural alignment of the surface models, for instance, by smoothening the alignment along a matched portion of the surface models. Hence, information (e.g. geometric or spatial) about the (refined) reconstructed model may be determined based on parameters (e.g. geometric or spatial) of the aligned surface models, and changes to said determined information may be evaluated to assess the optimisation of the refinement algorithm. Hereinunder various embodiments of reconstruction metrics are described that can be implemented as a cost function, alone or in any combination thereof. However, the skilled person understands that various metrics may be contemplated, and although examples are provided, the present technology is not limited to the herein discussed embodiments.

In some embodiments, the reconstruction metric that evaluates the alignment of the surface models as part of the cost function may comprise a proximity of the aligned surface models. The proximity may be determined based on a distance between the surface aligned surface models as a whole, for instance, by measuring the distance between the centres of the aligned surface models, or it may be determined based on a distance between the aligned portions of the surface models, for instance, by calculating the sum/mean of the distances along a fracture line. As previously explained, the closer the surface models are located, the more likely a reliable fitting has been realised. For example, if the distance between two surface models along an aligned portion is equal to zero, the alignment may be regarded as optimal. Accordingly, in any of these embodiments, the method may comprise determining a distance between the plurality of surface models, preferably along an aligned portion, and calculating the cost function based on said distance as a reconstruction metric.

In some embodiments, the reconstruction metric that evaluates the alignment of the surface models as part of the cost function may comprise a distance and/or orientation of a surface model to a surface normal defined at a point on an aligned surface model. As previously explained, portions of bone/object fragments located along the normal are more likely to match with the portion of the reference fragment from which the normal is defined, preferably if the normal is defined on a portion corresponding to the location of the fracture. Accordingly, in any of these embodiments, the method may comprise determining a portion of a surface model that intersects with the normal defined on a portion of a reference surface model, and calculating the cost function based on a distance and/or orientation of said surface model to said normal as a reconstruction metric.

In some embodiments, the reconstruction metric that evaluates the alignment of the surface models as part of the cost function may comprise a penetration depth of the aligned surface models. The penetration depth may be determined based on a distance between the surface aligned surface models as a whole, for instance, by measuring the distance between the centres of the aligned surface models, or it may be determined based on a distance between the aligned portions of the surface models, for instance, by calculating the sum/mean of the distances along a fracture line. As previously explained, the reconstruction algorithm may transform the surface model to (partially) penetrate a portion of another, e.g., second surface model. However, the greater the penetration depth, the less likely a reliable fitting has been realised. For example, if the penetrate depth between two surface models along an aligned portion is equal to zero, the alignment may be regarded as optimal. Accordingly, in any of these embodiments, the method may comprise determining a penetrate depth between the plurality of surface models, preferably along an aligned portion, and calculating the cost function based on said penetrate depth as a reconstruction metric.

In any of the above embodiments, information about a reconstruction metric can be implemented as parameters for the next refinement step, for instance, to calculate the next adjustment to the transformations of the aligned surface models. For example, if the distance between the aligned portions of surface models is too high, the next transformation may be calculated to reduce this distance. In another example, if the penetration depth between the aligned portions of surface models is too high, the next transformation may be calculated to reduce this penetration depth. Thus, in the manner described above, the adjustment to the transformations of the aligned surface models can be guided based on an evaluation of the selected reconstruction metrics. Although some simple examples have been provided for the manner in which the transformations are refined, it will be understood that the transformations necessary to fit the matched portions of surface models and thus also the transformations necessary to anatomical/structurally align the bone/object fragments of the broken bone/object can be more complex when applied to a clinical fracture, but the same general principles described above apply.

In this regard, in any of the above embodiments the refinement of the transformations has been described based on an evaluation of one reconstruction metric. However, it will be understood that the refinement of an anatomical/structural reconstruction of clinical fracture may be more complex and require a combination of different reconstruction metrics based on the alignment of large number of aligned surface models. In one embodiment, every reconstruction metric may be given the same weight such that the reconstruction metrics have the same impact on the calculation of the cost function. However, some metrics may be valuable for the reconstruction algorithm, for example, the penetration depth may be a more important metric than the distance between the portions of aligned surface models. Therefore, in another embodiment the reconstruction metrics may be given a different weight to change their impact on the calculation of the cost function.

Alternatively or in combination with any of the above embodiments, the reconstructed model may be evaluated based on a comparison with a reference model representing the bone/object in an unbroken form. The comparison may include the calculation of a “difference metric” that evaluates a deviation of the reconstructed model from the reference model of an unbroken bone/object, for instance, a deviation from a global shape of said reference model, along one or more dimensions, and/or a deviation from any particular point or portion of said reference model, such as identified landmarks. The deviation may be calculated based on any techniques known in the art for comparison of models, for instance, a superposition of the reconstructed model with the reference model of an unbroken bone/object.

In some embodiments, the reference model of the unbroken bone/object may be generated based on medical literature of one or more corresponding unbroken bone/objects, medical research of one or more corresponding unbroken bone/objects, and/or a drawing by a medical professional of one or more corresponding unbroken bone/objects. For instance, the reference model of the unbroken bone/object can be a statistical shape model of a reference unbroken bone/object that is similar in shape and size to the broken bone/object. The statistical shape model can be generated based on one or more parameters that define the characteristics of the unbroken bone/object.

In some embodiments, the reference model of the unbroken bone/object may be generated based on medical image data associated with an unbroken bone/object, advantageously acquired from the same subject of the broken bone/object. For example, a medical image of the broken bone/object may have been acquired at an earlier point in time when the bone/object was in an unbroken from, i.e., before the fracture. Alternatively, a medical image may be acquired of a symmetrically similar bone/object. The human body has bilateral symmetry, which means that for certain body parts, such as the legs and the arms, there are two copies of each bone/object. Accordingly, provided that one of the two copies is unbroken, a medical image of an unbroken bone/object may be acquired and processed to generate a reference model of an unbroken bone/object. The processing of the reference image data may, for example, include a mirroring of the reference model of the unbroken bone/object based on the bilateral symmetry of the body. A symmetrically similar bone/object will typically be a more accurate representation of the bone/object in an unbroken form than reference models based on, e.g., medical literature.

Advantageously, the comparison of the reconstructed model with a reference model of an unbroken bone/object is implemented as an additional check after one or more stopping conditions have been met. Hence, in such an embodiment, the comparison serves as an evaluation of the refined reconstructed model. If the evaluation based on the implemented difference metrics is regarded as, parts of the method may be. For instance, if a small deviation is calculated the refinement process may be continued further, e.g. for another number of iterations, or if a large deviation is calculated the entire reconstruction may be reiterated.

To complete the discussion FIG. 1, it is shown that the method further comprises a determining 390 of an anatomical reconstruction of the broken bone. The anatomical reconstruction may comprise determining the transformation needed to anatomically align the bone fragments 101 corresponding to the surface models 102 that have been aligned in the reconstructed model. However, although the anatomical reconstruction has been illustrated as a separate step, it will be understood that the necessary transformations may be determined during any of the above-discussed steps of the method, for instance, during the reconstruction and/or refinement steps. Hence, this final step is outlined in a dashed line to indicate that it is an optional feature.

The objective of the anatomical/structural reconstruction is, therefore, to generate an output that can be, for instance, displayed to a user of the method, for example, a healthcare professionals such as an operator of a medical imaging device or a surgeon. In an embodiment the output may comprise a reconstructed bone/object model and one or more transformation matrices to anatomically/structurally align the bone/object fragment to reconstruct the broken bone/object based on the reconstructed bone/object model. As mentioned above, the output may be generated during any of the earlier steps of the method, for instance, by tracking the transformations needed to anatomically/structurally align the surface models during the reconstruction and/or refinement steps. In this way, the output may be delivered faster or even continuously updated. Advantageously, the output is provided on a dedicated user interface to improve an interpretation by a user.

Although not illustrated in FIG. 1, in any of the embodiments described herein, the method may further comprise outputting the determined anatomically/structural reconstruction. More specifically, the processor 230 of the apparatus may output the determined transformations. For example, in some embodiments, the processor 230 may control a user interface to output (e.g. display) the determined transformation that anatomically/structurally aligns the bone/object fragments 101 of the broken bone/object with the corresponding portions of the generated surface models 102 and/or may control a memory 220 to store the determined transformation that anatomically/structurally aligns the bone/object fragments 101 of the broken bone/object with the corresponding portions of the generated surface models 102.

In some embodiments, the processor 230 may control a user interface to output a virtual reconstruction of the broken bone/object that shows the determined transformation being used to reconstruct the bone/object fragments of the broken bone/object to arrive at a bone/object in unbroken form, for instance by sequentially repositioning the bone/object fragments towards a position corresponding with the position of the corresponding surface model in the reconstructed model. Additionally, a set of instructions may be generated detailing the transformations, for example, an ordering of the bone/object fragments for reconstruction. In this way, the determined transformation is provided in an accessible form such that it can be used to plan or guide a medical procedure (such as surgery) to realign the broken bone/object into an unbroken form.

In any of the above embodiments, the quality of iterative refinement of the reconstructed model can be assessed by calculating a quality measure that quantifies how changing the position affects the quality of the reconstructed model. The value of the quality measure can be based on or more reconstruction metrics.

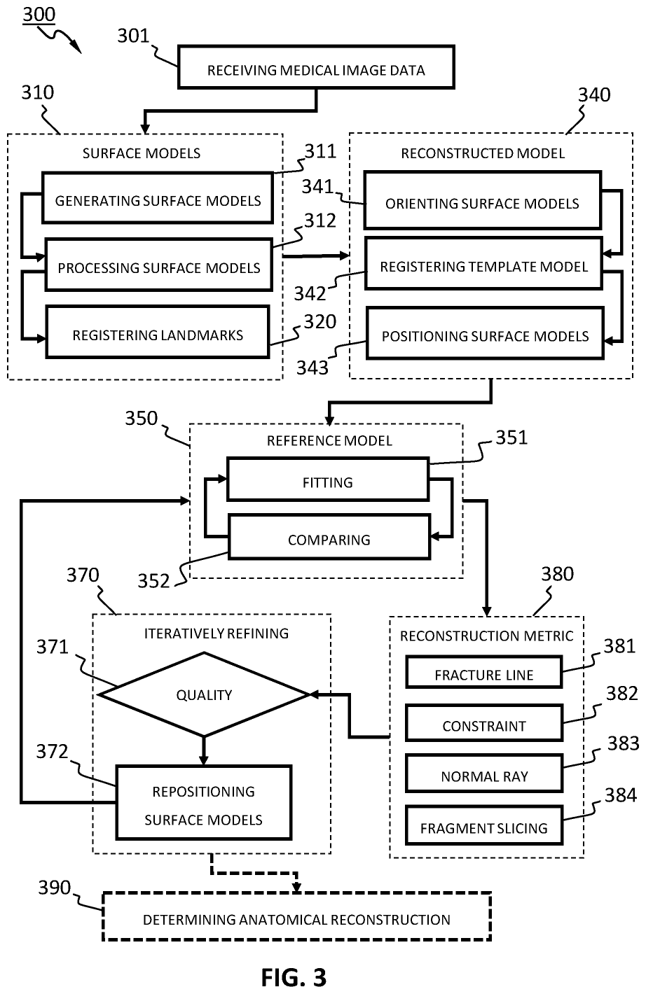

Expanding on the embodiment presented in FIG. 1, an extended version of the (computer-implemented) method for determining the anatomical reconstruction of a bone broken into two or more fragments will be discussed with reference to FIG. 3. It should be appreciated that the embodiment depicted in FIG. 3 builds upon the embodiment illustrated in FIG. 1. Consequently, any of the previously discussed embodiments related to FIG. 1 also constitute embodiments of the method outlined in FIG. 3.

FIG. 3 is a flow diagram of a (computer-implemented) method 300 for determining the anatomical reconstruction of a bone that has fractured into two or more bone fragments. It is understood that additional steps can be provided before, during, and after the steps of the method, and that some of the steps described can be replaced or eliminated for other implementations of the method.

In the shown embodiment, the method 300 begins at step 301 by receiving medical image data of a broken bone. This image data may encompass 3D medical image data, such as that obtained through a medical imaging modality producing a series of 2D image slices, which collectively construct a 3D volume. It is advantageous to subject the acquired medical image data to preprocessing procedures aimed at improving quality and reducing noise. Preprocessing activities may encompass operations such as noise reduction, contrast enhancement, and image registration to align multiple image slices.

At step 302, the method may comprise the identification and delineation of the bone fragments within the medical image data. This identification process can be executed through a segmentation process, preferably employing an automatic segmentation algorithm. The segmentation algorithm may entail the use of techniques like thresholding, region growing, or machine learning-based methodologies.

In a preferred embodiment, the identification and delineation of the bone fragments are accomplished through the application of a region growing algorithm. Region growing initiates from an initial seed point or points and systematically enlarges the region around these seed points by encompassing neighbouring pixels or voxels possessing akin properties or characteristics. If a neighbouring pixel or voxel satisfies the similarity criteria, it can be incorporated into the expanding region, becoming a new seed point. The process can subsequently iterate by inspecting the neighbours of this new seed point. This iterative region growing process persists, expanding the region by adding adjacent pixels or voxels that meet the specified similarity conditions. Termination of the process transpires when no more neighbours meet the criteria or when a predefined stopping condition is met, such as reaching a designated region size.

At step 310, the method may comprise providing of a plurality of 3D surface models 102, which serve as virtual representations of the bone fragments present in the medical image data. Specifically, one surface model per bone fragment can be created. The creation of these surface models can be achieved by applying the segmentation technique described previously, wherein connections between corresponding points or contours across image slices are established. This process may comprise interpolating between 2D contours to establish a continuous 3D surface.

The resulting 3D surface model can be in the form of a 3D mesh, constructed through the assembly of interconnected polygons. These polygons may take the shape of triangles, quadrilaterals, or other fundamental geometric shapes. The vertices located at the corners of these polygons within the surface model are denoted as vertices. These vertices represent the 3D spatial positions and determine the shape and structure of the 3D surface model. The identification of the plurality of bone fragments in the medical image data is carried out in step 302.

At step 312, the method may comprise generating the surface model by creating a geometric model that completely encloses one of the identified bone fragments, and iteratively shrinking the geometric model towards the surface of the bone fragment until it approximates the shape of the bone fragment. It is advantageous to select a spherical geometric model as it can accommodate a wide range of bone fragment forms and sizes. Nevertheless, alternative geometric models, such as cylinders, may be considered depending on the specific application.

At step 312, the method may comprise a surface cleaning step aimed at enhancing the functionality of the 3D surface model by removing imperfections, errors, or unwanted elements from the model. In some embodiments, the surface cleaning may comprise noise reduction (for instance, caused by data acquisition errors, imperfections in the 3D scanning process, or inaccuracies in the software), artifact removal to remove unintended or undesirable features on the 3D model's surface (such as gaps, holes, spikes, or isolated polygons), polygon optimisation to reduce the number of polygons, repairing irregularities (such as non-manifold edges, self-intersections, or overlapping triangles), hole filling to detect and fill holes in the 3D model, normal recalculation, and other techniques known in the art to improve continuity and quality of the 3D model's surface.

At step 312, the method may additionally or alternatively comprise a surface smoothing step configured to improve the quality of the 3D surface model. This surface smoothing process may include reducing irregularities, roughness, noise, and unwanted artifacts on the surface, which can enhance the overall quality of the model. Advantages, surface smoothing may involve multiple iterations, progressively refining the surface. However, care should be taken to preserve specific features of the bone fragment that are relevant to the later discussed landmark registration. The smoothed surface offers the advantage of reducing the irregularities typically encountered on bone surfaces, thereby facilitating landmark registration.

At step 320, the method may comprise the registration of landmarks on the surface model. Landmark registration can include the identification of points of interest on the model's surface and associating them with corresponding points on another surface model or a template. The landmark detection process is advantageously automated, focusing on distinctive features like corners, edges, or high-curvature points on the model's surface. Additionally, pattern matching against predefined shapes or patterns on the model's surface can be employed for this purpose

In some embodiments, the landmark registration process may include computing the curvature at each vertex within the 3D surface model. Curvature serves as a metric for assessing surface deviations from flatness at specific locations. High curvature values indicate significant surface deviations, making these points potential landmarks.

In some embodiments, the landmark registration may include computing the normal direction at each vertex. The normal vector characterizes the orientation perpendicular to the surface at a given point. Low deviation indicates strong anatomical correspondence, making these points potential landmarks.

In some embodiments, the landmark registration process may comprise normal ray matching by including the steps of: (1) selecting a subset of n source vertices from the set of vertices obtained through the preprocessing phase; (2) for each of these selected vertices, determining an intersection point by tracing the normal ray towards the target surface, (3) for each of these intersection points, assessing the intersection by evaluating the dot product between the normal at the intersection point and the source vertex; and (4) identifying a potential target vertex as the closest vertex to the intersection. Moreover, in cases where multiple intersection points qualify, the point with the lowest cost can be selected, corresponding to d(sᵢ, tᵢ)2/|n sᵢ·n tᵢ|.

In some embodiments, the landmark registration may comprise the identification of vertex regions achieved by grouping vertices with similar curvature values and normal directions. Vertices within the same region exhibit consistent curvature and normal direction characteristics. Within each identified vertex region, a representative vertex may be selected as a landmark. The criteria for selecting this representative vertex may include considerations like having the highest curvature or being centrally located within the region.

In some embodiments, the landmark registration process may include applying one or more constraints to the landmark selection based on the constraint satisfaction problem. The constraint may include the steps of (1) selecting vertices {s₁, . . . , sₙ} on the source mesh with the highest curvature; (2) for each source landmark sᵢ, identifying corresponding target vertices {t₁, . . . , tᵢmᵢ} with similar curvature, and (3) formulating a Constraint Satisfaction Problem (CSP) denoted as (X, D, C) where X represents the variables, which consist of {s₁, . . . , sₙ}, D signifies the domains, denoted as {{t₁₁, . . . , tᵢmᵢ} . . . {tₙ₁, . . . , tₙmₙ}} and C denotes the constraints, given as {d(sᵢ, sⱼ)≈d(tᵢ, tⱼ)|∀i,j ∈{1, . . . , n}: i≠j}, with d(xᵢ, xⱼ) representing the distance measurement between points xᵢ and xⱼ. Furthermore, the CSP can ensure that each source vertex sᵢ is linked to a single target vertex tᵢ ∈{tᵢ₁, . . . , tᵢmᵢ}. This linkage is such that the distances between all pairs of vertices on the source surface closely approximate the distances between the corresponding pairs of vertices on the target surface.

In any of the above embodiments, or a combination thereof, the matched landmarks can be registered between the two surface models, allowing adjustments in their positions and orientations to enhance the matching. The landmark matching process can establish correspondences between the identified landmarks on the surface model and their counterparts on another surface model, a partially reconstructed model consisting of two or more other surface models, or a reference model.

At step 340 the method may comprise the generation of a reconstructed model 110 representing a reconstructed form of the broken bone. The reconstructed model can be generated by repositioning each surface model to align with another surface model using corresponding landmark sets relative to a template 342. In accordance with previous steps, each surface model may already possess one or more landmarks registered on its surface, which can serve as corresponding points for alignment to another surface model. The registration of landmarks can be performed using any of the methods described above.

Before the alignment process is initiated, a set of landmarks that match the surface models can be selected. In some embodiments, the landmark set for initial alignment may include the selection of at least two landmarks that exhibit a high degree of correspondence. Alternatively, the landmark set may consist of at least three non-collinear landmarks. Aligning surface models in three dimensions is advantageously based on the selection of three landmarks that do not lie along a straight line.

The process of landmark matching may comprise one or more matching criteria designed to assess the suitability of the landmarks for alignment. These matching criteria can ensure that the selected landmarks are suitable for alignment and to prevent matches based on accidental similarities that may not align with anatomical expectations. The method may include various suitable matching criteria, including proximity, consistency, shape, context, and so on. The following anatomically relevant matching criteria are discussed below, although the method is not restricted to this list.

In some embodiments, landmark proximity can be included as a matching criterion. Landmarks are advantageously selected for their proximity to each other in the surface models and the reconstructed models. When landmarks are too far apart, it becomes more likely that they lack anatomical relevance. In some embodiments, the determination of landmark proximity may involve selecting at least a portion of vertices within a first vertex region of the first surface model and a corresponding portion of vertices within a second vertex region of the second surface model. Subsequently, the vertices from the first vertex region are matched with their corresponding vertices from the second vertex region, and distances between these vertices are calculated. Landmarks may be rejected if the distances between corresponding vertices exceed a predefined threshold. It is preferable that this threshold does not exceed a difference of 1.0 mm, and more preferably, it is set at 0.5 mm. In cases where no correspondence is established for all points, obstructive points are disregarded. It is possible that fewer than three points are obtained, indicating a potentially less favourable outcome compared to alternatives. To mitigate this, a better-scoring matching can be selected to limit its influence on the final solution.

In some embodiments, similarity in curvature or straightness can be included as a matching criterion. Landmarks are advantageously selected based on their similar curvature characteristics. Regions with dissimilar curvature are less likely to serve as suitable landmarks for alignment.

In some embodiments, the predefined selection matching comprises selecting at least a portion of vertices within a first vertex region of the first surface model and a corresponding portion of vertices within a second vertex region of the second surface model; determining the intersection points of the normal rays of the vertices of the first vertex region with the corresponding surface formed by the vertices of the second vertex region; calculating the relationship between the normal rays of the vertices of the first vertex region to the intersection points and the normal ray of the surface of the second vertex region at the intersection points; and rejecting the landmark if the relationship exceed a predefined threshold. Preferably, the aforementioned the threshold can include a dot product of at most 0.6 calculated between the normal ray of the vertex of the first vertex region to the intersection point and the normal ray of the surface of the second vertex region at the intersection point.

In some embodiments, similarity in normal direction can be included as a matching criterion. Landmarks advantageously exhibit a similar normal direction. Regions with dissimilar normal directions are less likely to be suitable landmarks for alignment.

In some embodiments similarity in normal direction can be determined by selecting a first vertex on the surface model, comparing the normal direction of the first vertex region with the normal directions of adjacent vertices, including one or more adjacent vertices into the vertex region if the angle between the normal directions is within a predefined threshold; and repeating these steps for each vertex included in the vertex region until a stopping condition is satisfied. Preferably, the aforementioned predefined threshold can include calculating the dot product between the normal ray of the first vertex and the normal ray of each adjacent vertex, and expanding the vertex region to include the adjacent vertex is the dot product is between 0.0 and 0.8, preferably between 0.0 and 0.5.

In some embodiments, anatomical consistency can be included as a matching criterion. Landmarks should advantageously exhibit anatomical relevance consistent with the expected anatomical structure of the object being reconstructed. For instance, when matching landmarks on bone fragments, they may correspond to well-known anatomical features such as joint surfaces, ridges, or tubercles.

In some embodiments, determining landmark proximity may comprise selecting at least a portion of vertices within a first vertex region of the first surface model and a corresponding portion of vertices within a second vertex region of the second surface model; matching the vertices of the first vertex region to the corresponding vertices of the second vertex region, calculating the distances between the vertices of the first vertex region to the corresponding vertices of the second vertex region; and rejecting the landmark if the distances exceeds a predefined threshold. Preferably, the aforementioned threshold is a difference of at most 1.0 mm between, more preferably 0.5 mm. As long as there is no correspondence for all points, the points that obstruct a solution can be ignored. If the latter results less than three landmark points, it is expected to score worse than alternatives. This can be circumvented, as the large cost that comes with a bad scoring algorithm. Therefore, influence on the end solution can be limited as a better scoring matching can be selected.

An initial ‘rough’ alignment can be performed for the surface models based on their existing landmark correspondences, primarily aiming to bring the surface models into an approximate alignment. This initial alignment process commences at step 341 by orienting the surface models according to the orientation of the landmarks and, particularly by computing the orientation of each landmark's normal vector. This computation can involve determining the principal or median axis or calculating the orientation of a line that best fits the shape of the landmark and its corresponding surface model. A 3D vector representing the orientation of the fragment may also be determined.

At step 342, the initial alignment process may involve the registering of a template model, which serves as a reference for aligning the surface models, as it possesses a known orientation, such as alignment with the global coordinate system or a predefined reference direction. This orientation defines the position and orientation of the template model within 3D space. The template model can be registered before orienting of the surface model, thereby serving as orientation reference for the other surface models to be oriented towards.

In some embodiments, the template model may be selected from the plurality of surface models. It is more efficient to designate one of the surface models as a reference point and restrict the positioning of the second surface model, rather than simultaneously adjusting the positions of both. The individual surface models can then be registered with respect to the template model, ensuring that they maintain the desired orientation. Alternatively, a template model may be generated in the form of a 3D model with a generic shape, such as a sphere, shaft, or rod. The generated template model can be advantageously generated using one or more of the surface models as a reference.

In some embodiments, the template model can be fitted onto the reference model before aligning the individual surface models with the template model. Preferably, the template model corresponds to the first surface model registered to the reference model, allowing the second and subsequent surface models to be positioned to align with the first surface model at the selected landmarks using the template model fitted onto the reference model and the reference model as references.

In some embodiment

In some embodiments the fitting of the template model onto the reference using a set of landmarks. Accordingly, the method may comprise the step of registering a plurality of landmarks matching the template model to the reference model. The landmarks may be registered using any of the embodiments described herein. Alternatively, other matching algorithms can be considered.

In some embodiments, the surface model with the largest dimensions can be registered as the first surface model and/or serve as the template model. Furthermore, the surface model with the second-largest dimensions can be registered as the second surface model, which can then be aligned with the aforementioned first surface model. The same process is repeated for any further surface models, such as the third, fourth, and so on. Aligning the surface models based on their dimensions offers advantages in terms of improving alignment accuracy. It is common in many fractures for the bone to break into one large fragment, such as the shaft, and one or more smaller fragments. Therefore, aligning the larger fragments with the reference model is typically less complex than fitting the smaller fragments. Afterwards, the already aligned larger fragments can serve as additional reference points to further enhance alignment accuracy.

As used herein, “dimension” encompasses the size (e.g., length, width, circumference) and/or volume of the surface models. Consequently, selecting one or more surface models based on their relative dimensions may involve calculating the dimensions of the plurality of surface models. These dimensions may already be available during the generation of the surface models, as they often involve defining one or more dimension-related parameters.

At step 343, the initial alignment process may comprise the positioning of the surface models utilizing the template model as a registration reference to ensure the desired orientation is maintained. For this purpose, an alignment algorithm can be employed to facilitate the automatic alignment of the surface models with the template model efficiently. In some embodiments, the algorithms may include Iterative Closest Point (ICP) or feature-based alignment methods.

In any of the above embodiments, the steps related to the initial alignment process can be repeated for each of the plurality of surface models until all surface models are aligned at a corresponding landmark set relative to one or more template models. This is particularly relevant for complex fractures that involve multiple smaller bone fragments. Each iteration may comprise the generation of a new template serving as reference for aligning the further surface model.

In the latter scenario involving more than two bone fragments, it can be advantageous to work sequentially, aligning additional surface models onto a partially reconstructed model that comprises a portion of aligned surface models. For instance, a first and a second surface model can be aligned to create a partially reconstructed model consisting of the first and second surface models. Subsequently, a third surface model can be aligned to this partially reconstructed model, resulting in a further partially reconstructed model that encompasses the first, second, and third surface models, and so on for each subsequent surface model. This approach of successive partial reconstructions helps ensure that the surface models are progressively transformed to better match the position and orientation of the other aligned surface models as closely as possible, thereby contributing to more accurate alignment results compared to aligning all surface models simultaneously.

Continuing with FIG. 3, at step 350, the initial alignment quality may be assessed by comparing the reconstructed model to the reference model representing an unbroken form of the bone. The reference model essentially serves as a ‘gold’ standard for comparison that is be advantageous in setting a benchmark for evaluating the quality of the reconstructed models. As previously described, the reference model may take the form of a statistical shape model of an unbroken bone that closely resembles the shape and size of the broken bone. Alternatively, it could be a medical image of an unbroken bone, derived from a mirrored or earlier dated medical image that shares similarities in shape and size with the fractured bone. Alternatively, the template model can be implemented as the reference model to reduce the reconstruction complexity.

At step 351, the process of comparing the reconstructed model to the reference model can commence by involving the utilization of a fitting algorithm designed to align the reconstructed model and the reference model. This alignment process may entail adjusting the parameters of the reference model to minimize dissimilarities between the model and the observed image data. The fitting algorithm can include methods like gradient descent, least squares, among others. During the fitting process, a dissimilarity or similarity metric can be defined to quantitatively measure how well the reference model aligns with the reconstructed model, specifically by assessing differences in shape and appearance. The dissimilarity or similarity metric may encompass measures such as mean square error (MSE), normalized cross-correlation, or other specialized metrics.

At step 352, the results of the aforementioned comparing process may be employed to determine one or more misalignment parameters that require adjustment to enhance the overall alignment. Optimization techniques may be implemented that can include translation, rotation, scaling, and deformation of either the reference model or the reconstructed model, or both, to attain the optimal fit. This adjustment aims to rectify any misalignment discrepancies between the reconstructed model and the reference model. At step 370, an iterative refinement process may be applied to the reconstructed model to achieve a more precise alignment. This iterative refinement can involve optimizing the positions and orientations of the surface models based on landmark correspondences. The refinement process can be executed through a reduction step that centres around optimizing a cost function to achieve a higher degree of alignment accuracy between the surface models.

At step 371, the iterative refinement process may be initiated by establishing a quality measure that quantifies how changes in position impact the quality of the reconstructed model. This process can continue until a predetermined stopping condition is met. These stopping conditions may include a maximum number of iterations or a threshold indicating sufficiently small changes in parameters. As the optimization progresses, the alignment quality improves, resulting in a more precise fit between the objects or models and the observed data. The objective of the iterative refinement is to optimize this quality measure by iteratively adjusting the positions of one or more surfaces at step 372.

In some embodiments, the quality measure may encompass the formulation of a cost function or an objective function, utilizing a set of quality measures to assess dissimilarities between the reconstructed model and the reference model. The cost function quantifies the alignment quality between the surface models and the reference model, specifically by gauging the dissimilarity or error between the aligned surface models and the reference model

At step 380, a score may be calculated to assess the quality measure, based on one or more reconstruction metrics designed to evaluate the alignment accuracy. These reconstruction metrics may include various aspects of alignment quality such as, at step 381, fracture line matching, at step 382, applying constraints, at step 383, comparing surface normal, and at step 384, fragment slicing. It should be noted that these reconstruction metrics can potentially be integrated into a composite cost function to provide an overall evaluation of alignment accuracy. Furthermore, the method can be expanded to include additional metrics, and the weighting of these metrics in the quality measure may vary depending on the application and the complexity of the fracture.

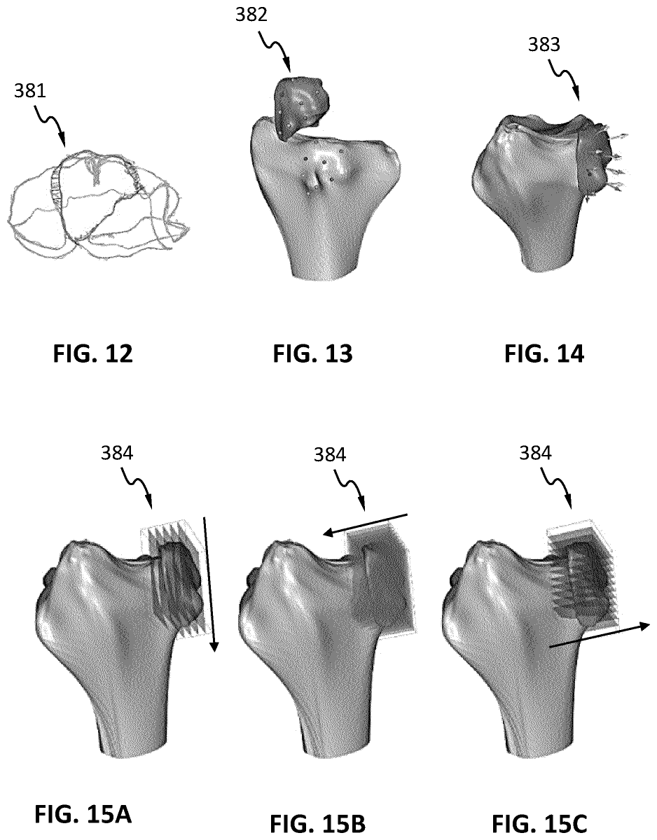

In some embodiments, fracture line matching can be included as one of the reconstruction metrics. Fracture line matching evaluates how well the fracture lines in the reconstructed model align with those in the reference model. This assessment can involve comparing corresponding points along the fracture lines and quantifying dissimilarities or distances between them. Distance metrics such as Euclidean distance or more robust measures like Hausdorff distance may be applied. FIG. 12 presents an example of how fracture line matching 381 can be implemented as a reconstruction metric 380.

In some embodiments, a constraint satisfaction problem (CSP) can be included as one of the reconstruction metrics. CSP entails the formulation of constraints based on established relationships between components or landmarks in the models. The cost function then assesses the degree to which these constraints are satisfied. For example, if certain landmarks should maintain fixed distances or angles relative to each other, the cost function measures the deviations from these specified constraints. FIG. 13 presents an example of how CSP 382 can be implemented as a reconstruction metric 380.

In some embodiments, normal ray matching can be included as one of the reconstruction metrics. Normal ray matching assesses alignment by comparing the surface normals of the reconstructed model to those of the reference model. The quality of alignment is determined by how closely the normals align at corresponding points on the surfaces. Differences in normal directions can be quantified using angular metrics or vector differences. FIG. 14 presents an example of how normal ray matching 383 can be implemented as a reconstruction metric 380 in the method presented in FIG. 3.

In some embodiments, fragment slicing can be included as one of the reconstruction metrics. Fragment slicing involves the segmentation of the reconstructed and reference models into 2D sections, which are subsequently compared. Advantageously each fragment is sliced in three direction based on the 3D space, meaning the x-, y-, and z-direction, to match the contour of the surface models and the reference model. This comparison may employ measures such as cross-correlation to evaluate how well the slices align concerning intensity or shape. Alignment quality can be assessed based on metrics like the correlation coefficient or other similarity measures. FIGS. 15A-15C present examples of how different directions of fragment slicing 384 can be implemented as a reconstruction metric 380, each figure depicting a different slicing direction within the 3D space.

Returning to FIG. 3, steps 370 and 380 are depicted as iteratively linked, indicating that after repositioning the surface models, the quality measure may be reevaluated using any of the aforementioned reconstruction metrics to determine if the quality score has improved. If the score demonstrates improvement, it may indicate that the alignment is progressing optimally. The optimization process can continue until the cost function is optimised, signifying the achievement of the best possible alignment. Once optimised, the surface models can be joined into a (partially) reconstructed model.

As previously described, the method can be applied to more than two surface models, such as three, four, or more surface models. In such scenarios, it may be advantageous to optimize the alignment of two surface models before adding a third surface model to the partially reconstructed model. For instance, the quality measure may be refined using the iterative approach described until the partially reconstructed model reaches a predefined alignment quality. This process may then be repeated for each additional surface model until all fragments are aligned and integrated into a unified reconstructed model. At step 390, the method may comprise determining an anatomical reconstruction of the broken bone by comparing the position of the identified bone fragments in the medical image data with the position of the corresponding surface models in the reconstructed model. Optionally, one or more post-processing steps may be included to further refine the reconstructed model, ensuring its suitability for use in surgical planning, meeting specific output standards, or achieving desired anatomical accuracy.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment.

As used herein, the terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited members, elements or method steps also include embodiments which “consist of” said recited members, elements or method steps. The singular forms “a”, “an”, and “the” include both singular and plural referents unless the context clearly dictates otherwise.

As used herein, relative terms, such as “left,” “right,” “front,” “back,” “top,” “bottom,” “over,” “under,” etc., are used for descriptive purposes and not necessarily for describing permanent relative positions. It is to be understood that such terms are interchangeable under appropriate circumstances and that the embodiment as described herein are capable of operation in other orientations than those illustrated or described herein unless the context clearly dictates otherwise.

Objects described herein as being “adjacent” to each other reflect a functional relationship between the described objects, that is, the term indicates the described objects must be adjacent in a way to perform a designated function which may be a direct (i.e. physical) or indirect (i.e. close to or near) contact, as appropriate for the context in which the phrase is used.

Objects described herein as being “connected” or “coupled” reflect a functional relationship between the described objects, that is, the terms indicate the described objects must be connected in a way to perform a designated function which may be a direct or indirect connection in an electrical or nonelectrical (i.e. physical) manner, as appropriate for the context in which the term is used.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, the term “about” is used to provide flexibility to a numerical value or range endpoint by providing that a given value may be “a little above” or “a little below” said value or endpoint, depending on the specific context. Unless otherwise stated, use of the term “about” in accordance with a specific number or numerical range should also be understood to provide support for such numerical terms or range without the term “about”. For example, the recitation of “about 30” should be construed as not only providing support for values a little above and a little below 30, but also for the actual numerical value of 30 as well.

The recitation of numerical ranges by endpoints includes all numbers and fractions subsumed within the respective ranges, as well as the recited endpoints. Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the disclosure described herein are capable of operation in other sequences than described or illustrated herein.

Reference in this specification may be made to devices, structures, systems, or methods that provide “improved” performance (e.g. increased or decreased results, depending on the context). It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

In addition, embodiments of the present disclosure may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the present disclosure may be implemented in software (e.g., instructions stored on non-transitory computer-readable medium) executable by one or more processing units, such as a microprocessor and/or application specific integrated circuits. As such, it should be noted that a plurality of hardware and software-based devices, as well as a plurality of different structural components may be utilized to implement the technology of the present disclosure. For example, “servers” and “computing devices” described in the specification can include one or more processing units, one or more computer-readable medium modules, one or more input/output interfaces, and various connections connecting the components.

### Examples

Examples of an implementation of the technology according to the present disclosure is given hereinbelow. The provision of examples is meant to aid the reader in understanding the technological concepts more easily, but it is not meant to identify the most important or essential features thereof, nor is it meant to limit the scope of the present disclosure.

### Example 1: Exemplary Fragment Reconstruction Framework

An exemplary fragment reconstruction framework is visualized in FIG. 3. Implementation of this framework may be regarded as a preferred embodiment of the herein disclosed technology.

First, smooth fragment surfaces are derived from the voxelized, segmented fragments that were delineated in a medical image, for example, from an X-ray CT image, after which they are annotated with potential landmarks. Next, an initial alignment between the fragments is obtained by combining Iterative Closest Point (ICP) transformations and translations. Finally, the fragments are iteratively transformed by alternately translating and performing a landmark transformation, until convergence is reached.

Starting from manually segmented fragments with irregular surfaces, pre-processing of medical image data is often a necessary first step. In the present example, the medical image data pre-processing consists out of three steps: cleaning, smoothing and defining potential landmarks.

Manually segmented fragments may contain internal trabecular structures. To simplify the computation in the next steps, those structures are removed using Meshlab's “Select by Vertex Quality” filter. Next, the surface is smoothed by applying a shrink-wrapping algorithm. For each fragment, a sphere fully encompassing the fragment is defined. This sphere is then iteratively shrunk to approach the shape of the fragment, resulting in a relatively smooth surface. An additional smoothing is applied to cope with wrinkles introduced during shrinking. Shrink wrapped smoothing allows the global shape of a fragment to be exploited, without being distracted by small details or holes in the mesh. Finally, region growing is applied to the original fragment to identify the largest region of vertices with little differences in curvature and normal direction. Such vertices are presumably located on the exterior of the radius and thus corresponding to a point on the target surface. In this example, the mirrored contralateral radius was used as a target surface. In what follows, registration of a fragment with respect to a target is performed using a subset of vertices located on the exterior of the radius, unless stated otherwise.

The fractured and mirrored contralateral radius are initially not aligned relative to each other. Hence, a course alignment is performed between the source and target surface. First, the optimal transformation is calculated for the shaft fragment only, through ICP and a slicing technique and applied to the complete set of fragments. Next, the smaller fragments are joined to form a single joined fragment. An Oriented Bounding Box (OBB) is calculated for this joined fragment, as well as for the mirrored contralateral radius. The joined fragment is translated such that the centre of its distal OBB plane coincides with the centre of the distal OBB plane of the mirrored contralateral radius. An ICP transformation of the joined fragment with respect to the mirrored radius provides further refinement. The small fragments are then individually translated towards the centre to a limited extent as they are typically torn apart and away from the centre. Finally, an ICP transformation of the joined fragment is performed with respect to the mirrored contralateral radius.

The refinement is performed by iteratively processing each fragment. Fragments are iteratively translated and landmark-transformed until convergence. Both translation and landmark determination method are selected among several options using a cost function f that is based on distance and normal direction, as well as on a metric to avoid fragments penetrating each other too much. The cost function is empirically determined. Let s={sᵢ ∨i=0, . . . , n} and t={tᵢ ∨i=0, . . . , n} denote a set of source vertices and the set of corresponding target vertices, respectively.

Then, the cost function is defined as

$$f ( s , t ) = \frac{{\sum }_{i} d ( {s}_{i} , {t}_{i} )}{100} - {( {\sum }_{i} {n}_{{s}_{i}} \cdot {n}_{{t}_{i}} )}^{2} - 100 \cdot ⋁ E ( s , {S}_{t} ) ⋁$$

where d(sᵢ, tᵢ) is the distance between vertices sᵢ and tᵢ, nₛ_{ᵢ} and nₜ_{ᵢ} are the surface normal in sᵢ and tᵢ, respectively, and E(s, Sₜ) is the subset of vertices within s that are enclosed in the target surface Sₜ, which is the mirrored contralateral radius.

For every fragment, an OBB is defined. Then, for each of the six sides of the OBB, a translation vector is defined as a vector from the centre of the OBB to the centre of that particular side. To avoid disproportionate movements, the translation vectors were scaled by a small factor k, where in the present example k was set to 0.01.

The landmarks for the landmark transformation are determined by one of the following approaches:
Constraint Satisfaction Problem (CSP): Landmark selection is bound to the following constraints: first, the n vertices {s₁, . . . , sₙ} on the source mesh with the highest curvature are selected. Second, for every source landmark sᵢ, the corresponding target vertices {tᵢ₁, . . . , tᵢₘ_{ᵢ}} with approximately the same curvature are identified. Third, a CSP is defined as (X,D,C), with variables X={s₁, . . . , sₙ}, domains D={{t₁₁, . . . , tᵢₘ_{₁}} . . . , {tₙ₁, . . . , tᵢₘ_{ₙ}}} and constraints C={d(sᵢ, sⱼ)≈d(tᵢ, tⱼ)|∀i, j∈{1, . . . , n}: i≠j} with d(xᵢ, xⱼ) the distance between points xᵢ and xⱼ. By the CSP, every source vertex s is linked to a target vertex tᵢ ∈{tᵢ₁, . . . , tᵢₘ_{ᵢ}} so for every pair of source vertices (sᵢ, sⱼ), d(tᵢ, tⱼ)≈d(sᵢ, sⱼ).
Normal ray comparison: In the normal ray approach, a subset of source vertices is selected from the set of vertices resulting from the processing step. Next, for each of these source vertices, the normal ray intersects with the target surface. If an intersection is found and the angle between the normal of the intersection point and source vertex does not exceed 53°, the closest vertex to this point is a potential target vertex. In case of multiple qualifying intersection points, the point with the lowest cost, being d(sᵢ, tᵢ)²/nₜ_{₁}·nₜ_{₁} ∨, will be chosen.
Fragment slicing: In this approach, an OBB is determined around the fragment. For each two opposite sides of the OBB, a series of equally spaced planes parallel to and in between of the two sides is determined. Intersecting these planes with both fragment and mirrored contralateral radius results in two series of 2D lines, which are now source and target in an ICP transformation. The more complex 3D problem is reduced to a layered 2D problem. The landmarks determined during pre-processing are not used in this approach. After successful registration of a fragment, the fragment is joined with the other fragments.

After successful registration of a fragment, the fragment is joined with the other fragments.

### Example 2: Experiments on a Fractured Distal Radius Bone

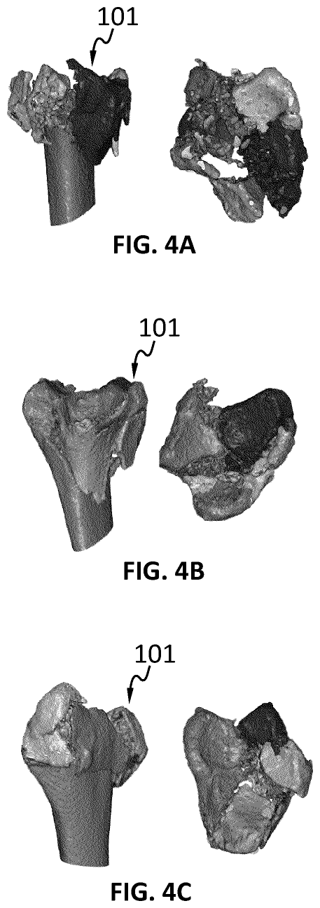

Three CT images from patients with a distal radius fracture were used to validate the fragment reconstruction algorithm of Example 1. First, the CT images were thresholded using Mimics 24.0 (Materialise, Belgium) to segment all fragments from bilateral high resolution CT scans of distal radius fractures. Side- and top-views of the radius fragment datasets are shown FIGS. 4A-4C. For the case shown in FIG. 4A, the styloid process was fractured into 8 fragments. The other datasets, shown in FIG. 4B and FIG. 4C, both had a partially intact styloid process. They consist of 10 and 5 fragments, respectively. The largest fragment typically consists of the shaft together with the head of the fractured radius. The other fragments are rather small and form the distal end. Note that all small fragments are displaced towards the shaft.

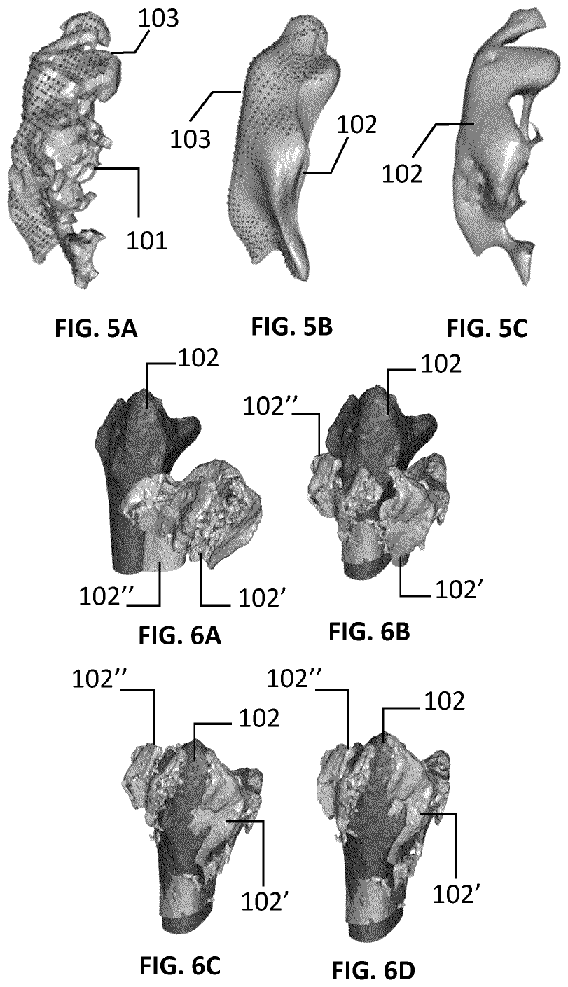

The fragments showed highly irregular surfaces for three main reasons. First, the dataset was segmented manually. Second, the fragments were voxelized, which results in a discretized surface. Finally, segmentation was performed slice by slice, resulting in irregular, non-smooth fragment surfaces. Due to the highly irregular surfaces of the fragments, preprocessing was necessary. The 3D fragment models contained internal structures and protrusions, which complicated curvature estimation and computation of normal vectors during the reconstruction process. An overview of the preprocessing on a single fragment of the dataset is shown in FIG. 5. Specifically, FIG. 5A shows the original bone fragment from two viewpoints together with the selected landmarks 103. FIG. 5b shows a surface model 102 based on the shrink wrapped smoothed fragment, together with the corresponding landmarks 103. FIG. 5b shows a surface model 102 after VTK smoothing, showing sharp protrusions.

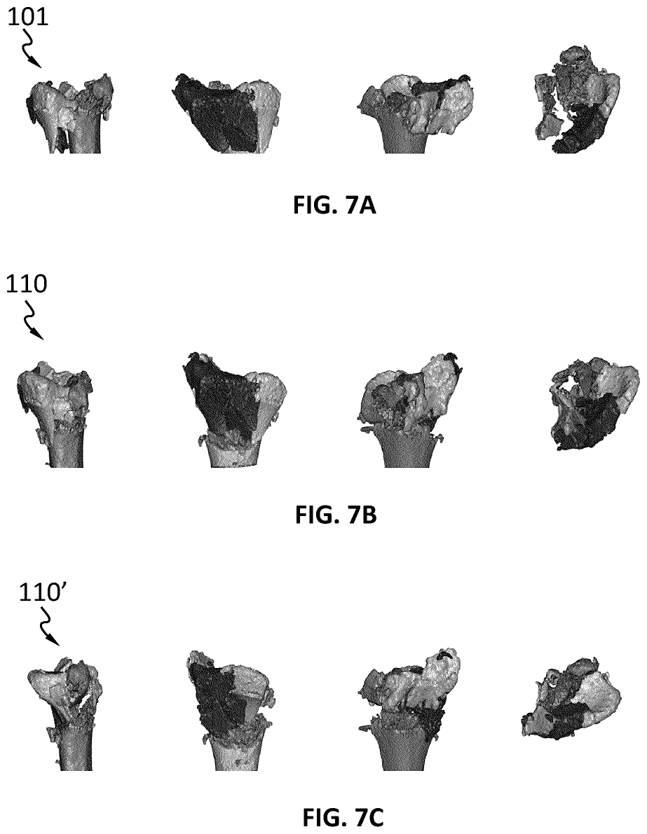

After preprocessing, an initial alignment of the surface model (source) is performed with the surface model corresponding with the contralateral radius (target) is performed. FIG. 6A shows the initial alignment situation. FIG. 6A shows an alignment of the shaft with the mirrored contralateral radius. FIG. 6A shows an alignment of the smaller fragments in line with the shaft. FIG. 6D shows the refinement based on small translations to refine the alignment of the smaller fragments with the shaft. To evaluate the performance of the reconstruction algorithm of Example 1, three different fragmented radii were manually reconstructed by an orthopedic surgeon for reference. FIG. 7A shows the bone fragment 101 at their initial positions from four different viewing angles (i.e., a front view, a rear view, a side view, and a top view), FIG. 7B shows the anatomical reconstruction 110 by the automated reconstruction algorithm of Example 1 (from the same viewing angles), and FIG. 7C shows the anatomical reconstruction 110′ by the surgeon via an interactive (manual) method (from the same viewing angles).

By comparing FIG. 7B with FIG. 7C, it can be observed that the automated reconstruction of Example 1 closely resembles the manual reconstruction by the surgeon. Disregarding the two smallest fragments, all fragments are repositioned near to their correct location. Only the final position of the smallest fragment has a larger cost than its initial position in terms of triangle area. Furthermore, the outer edge of the styloid process is reconstructed in an anatomically reasonable way with little remaining gaps.

In the evaluation of reconstruction results, the global shape of the reconstructed bone is key. The shape of the reconstruction should closely match that of the original radius. Therefore, shrink wrapping was applied to the automated reconstruction (FIG. 7B), the surgeon's reconstruction (FIG. 7C), and the mirrored contralateral radius. For both the automated reconstruction and the surgeon's reduction, the distance to the mirrored contralateral radius was calculated.

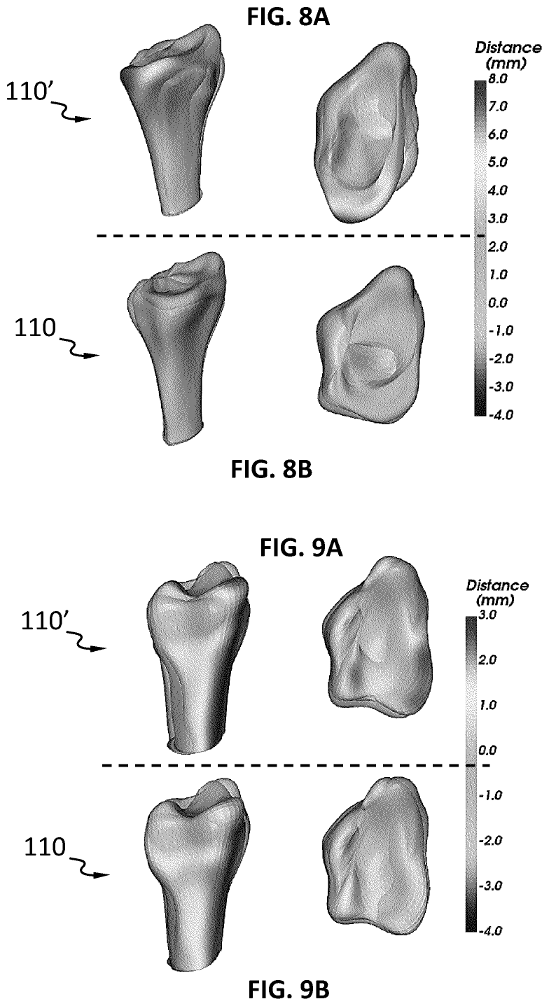

In FIG. 8, the distance metric is visualized for the second dataset, specifically, the surgeon's reconstruction 110′ is shown in FIG. 8A and the automated reconstruction 110 in FIG. 8B. Based on a comparison of these two distance metrics, fewer outliers are present in the automated reconstruction 110 (FIG. 88).

In FIG. 9, the distance metric is visualized for the third dataset, specifically, the surgeon's reconstruction 110′ is shown in FIG. 9A and the automated reconstruction 110 in FIG. 98. Like the previous results, there are fewer outliers present in the automated reconstruction 110 (FIG. 98).

1. A computer-implemented method for automatically determining an anatomical reconstruction of a broken bone, whereby the broken bone is broken into a plurality of bone fragments:
comprising the steps of:
receiving medical image data associated with the broken bone;
identifying the plurality of bone fragments in the medical image data, generating a plurality of three-dimensional (3D) surface models that virtually represent the bone fragments, including at least a first and a second surface model, and registering a plurality of landmarks matching the first to the second surface model; wherein the registration of landmarks comprises identifying a plurality of vertex regions on the first and the second surface models, wherein a vertex region comprises a plurality of vertices with comparable curvature and normal direction, and matching one or more vertex regions of the first surface model with one or more vertex regions of the second surface model in accordance with a predefined matching criterion;
generating a reconstructed model that represents a reconstructed form of the broken bone by selecting at least two landmarks yielding the highest degree of correspondence; providing a reference model that represents an unbroken form of the bone; and positioning the second surface model to align with the first surface model at the selected landmarks using the reference model as reference; and optionally, repeating the positioning for each of the plurality of surface models until all surface models are aligned at corresponding landmarks relative to the reference model;
iteratively refining the reconstructed model by selecting one or more different landmarks, repositioning the second surface model to align with the first surface model at the different landmarks, and evaluating a quality measure that quantifies how the repositioning affects the quality of the reconstructed model, until a stopping condition is satisfied;
wherein the quality measure comprises comparing the reconstructed model to the reference model, thereby identifying one or more alignment discrepancies between the reconstructed model and the reference model, and assigning a score to the alignment discrepancies based on one or more reconstruction metrics; and
determining an anatomical reconstruction of the broken bone by comparing the position of the identified bone fragments in the medical image data with the position of the corresponding surface models in the reconstructed model.

2. The computer-implemented method according to claim 1, wherein generating the reconstructed model further comprises the step of: registering the first surface model as a template model, fitting the template model onto the reference model, and positioning the second surface model to align with the first surface model at the selected landmarks using the template and reference models as reference.

3. The computer-implemented method according to claim 1, wherein the surface model having the largest dimensions is selected as the first surface model, and optionally the surface model having the second largest dimensions is selected as the second surface model, and so on for the plurality of surface models.

4. The computer-implemented method according to claim 1, wherein the surface model is generated by creating a geometric model that completely encloses one of the identified bone fragments, and iteratively shrinking the geometric model towards the surface of the bone fragment until it approximates the shape of the bone fragment; optionally wherein the geometric model comprises a sphere.

5. The computer-implemented method according to claim 1, wherein the vertex region is identified by selecting a first vertex on the first surface model, comparing the normal direction of the first vertex region with the normal directions of adjacent vertices, including one or more adjacent vertices into the vertex region if the angle between the normal directions is within a predefined threshold; and repeating these steps for each vertex included in the vertex region until a stopping condition is satisfied; optionally wherein the predefined threshold includes calculating the dot product between the normal ray of the first vertex and the normal ray of each adjacent vertex, and expanding the vertex region to include the adjacent vertex is the dot product is between 0.0 and 0.8, preferably optionally between 0.0 and 0.5.

6. The computer-implemented method according to claim 1, wherein the landmark is registered through the steps of: selecting one or more vertices from the vertex regions of the first surface model, for each of the selected vertices, determining an intersection point by tracing the normal ray towards the corresponding vertex region of the second surface model: assessing the intersection by evaluating the dot product between the normal at the intersection point and the vertex region of the second surface model; and registering a potential landmark as the closest vertex to the intersection.

7. The computer-implemented method according to claim 1, wherein the landmark is registered through the steps of (1) selecting one or more vertices with the highest curvature of the plurality of vertices on the first surface model: (2) for each selected vertices, identifying a corresponding plurality of vertices with similar curvature on the second surface model: formulating a constraint satisfaction problem (CSP) including at least constrains representing the distance measurement between corresponding the selected vertices of the first surface model and the corresponding vertices of the second surface model; and registering a potential landmark between all vertices of the first surface model that closely approximate the distances between the corresponding pairs of vertices on the second surface model.

8. The computer-implemented method according to claim 1, wherein the predefined matching criterion comprises selecting at least a portion of vertices within a first vertex region of the first surface model and a corresponding portion of vertices within a second vertex region of the second surface model; matching the vertices of the first vertex region to the corresponding vertices of the second vertex region, calculating the distances between the vertices of the first vertex region to the corresponding vertices of the second vertex region; and rejecting the landmark if the distances exceeds a predefined threshold; optionally wherein the threshold is a difference of at most 1.0 mm between.

9. The computer-implemented method according to claim 1, wherein the landmarks are registered by determining a curvature of at least two surface models; and wherein the reconstructed model is generated by identifying regions with substantially complementary curvature between the surface models, and aligning the surface models along the regions with complementary curvature.

10. The computer-implemented method according to claim 1, wherein the landmarks are registered by determining a distance between at least two surface models; and wherein the reconstructed model is generated by identifying points and/or regions of nearest distance between the surface models, and aligning the surface models along the points and/or regions of nearest distance.

11. The computer-implemented method according to claim 1, wherein the landmarks are registered by defining a normal ray based on a surface of at least one surface model; and wherein the reconstructed model is generated by identifying points of one or more surface models intersecting along the normal ray, and aligning the surface models along the intersecting points and/or regions.

12. The computer-implemented method according to claim 1, wherein the predefined selection matching comprises selecting at least a portion of vertices within a first vertex region of the first surface model and a corresponding portion of vertices within a second vertex region of the second surface model; determining the intersection points of the normal rays of the vertices of the first vertex region with the corresponding surface formed by the vertices of the second vertex region; calculating the relationship between the normal rays of the vertices of the first vertex region to the intersection points and the normal ray of the surface of the second vertex region at the intersection points; and rejecting the landmark if the relationship exceed a predefined threshold;
preferably optionally wherein the threshold is a dot product of at most 0.6 calculated between the normal ray of the vertex of the first vertex region to the intersection point and the normal ray of the surface of the second vertex region at the intersection point.

13. The computer-implemented method according to claim 1, wherein the landmarks are registered by slicing at least one surface model into a plurality of parallel 2D slices, and wherein the reconstructed model is generated by identifying points and/or regions of one or more surface models intersecting along at least one of the 2D slices, and aligning the surface models along the intersecting points and/or regions; optionally wherein the landmark is assigned by slicing at least two surface models into a plurality of parallel 2D slices, and wherein the reconstructed model is generated by identifying points and/or regions of intersecting 2D slices of at least two surface models, and aligning the surface models along the intersection points and/or regions.

14. The computer-implemented method according to claim 1, wherein an Oriented Bounding Box (OBB) is generated for at least two surface models, the OBBs having a centre and edges, and wherein the reconstructed model is generated by aligning the centres of the OBBs of the surface models, and aligning the surface models along their corresponding OBBs.

15. The computer-implemented method according to claim 1, wherein quality measures include a cost function that measures how the reconstruction metric is affected by the change in position and the stopping condition comprises a convergence of the cost function.

16. The computer-implemented method according to claim 1, wherein the quality measure further includes identifying one or more fracture lines in the medical image data, comparing the reconstructed model to the fracture lines, thereby determining one or more alignment discrepancies between the reconstructed model and the fracture lines, and assigning a score to the alignment discrepancies based on a reconstruction metric.

17. The computer-implemented method according to claim 1, wherein the quality measure further includes selecting at least one vertex of the vertex region of the first surface model, wherein the vertex region is used as landmark for matching at least two different surface models, determining at least one intersection point of the normal ray of the vertex of the first surface model with at least a portion of a surface of the second surface model, calculating the relationship between the normal ray of the vertex of the first surface model to the intersection point and the normal ray of the surface of the second surface model at the intersection point, and assigning a score to the normal ray alignment discrepancies based on a reconstruction metric.

18. The computer-implemented method according to claim 17, further comprising calculating the dot product between the normal ray of the vertex of the first surface model to the intersection point and the normal ray of the surface of the second surface model at the intersection, and rejecting the landmark if the dot product is above at most 0.6.

19. The computer-implemented method according to claim 1, further comprising outputting the anatomical reconstruction of the broken bone to a user, optionally as a set of instructions as part of preoperative planning.

20. A computer program product for implementing, when executed on a processor, a method according to claim 1 when provided with image data as input, optionally from a medical imaging device.

21. A system comprising a medical imaging device and a processor, wherein the medical imaging device is adapted for acquiring a plurality of medical images, and wherein the processor is adapted for receiving the medical images as image data and performing the steps of the method according to claim 1.
